(19) United States
(12) Patent Application Publication
(10) Pub. No.: US 2025/0068829 A1
(43) Pub. Date: Feb. 27, 2025

(54) CREATION AND PERSONALIZATION OF COMPOSITE FONTS

(71) Applicant: Adobe Inc., San Jose, CA (US)

(72) Inventors: Oliver Brdiczka, San Jose, CA (US); Nipun Jindal, Delhi (IN)

(73) Assignee: Adobe Inc., San Jose, CA (US)

(21) Appl. No.: 18/238,123

(22) Filed: Aug. 25, 2023

(51) Int. Cl. G06F 40/109

(52) U.S. Cl. CPC G06F 40/109

(57) ABSTRACT

Techniques for creation and personalization of composite fonts are described. In one embodiment, a method includes receiving an input font sequence comprising font embeddings for a first font and sequence information for the first font, the font embeddings comprising numerical vectors, predicting a second font based on the font embeddings of the first font and the sequence information for the first font using a transformer-based machine learning model, selecting a character from the second font, and adding the character of the second font to a character of the first font to generate a set of characters for a composite font. Other embodiments are described and claimed.

### BACKGROUND

A font editing system, also known as a font editor, is a type of software that allows users to create or modify typefaces, which are often called “fonts.” A font comprises a set of characters, including letters, numbers, symbols, and punctuation marks. Each of these characters is designed with specific shapes, sizes, weights, and styles, collectively giving the font its unique appearance. The font editing system typically provides a set of tools that offer a wide range of options for designing and customizing fonts. While these tools facilitate creation of new fonts, however, manually creating a custom font remains a time-consuming process, often requiring a trial and error approach to designing individual characters, adjusting spacing between characters, and modifying other font properties or characteristics in an attempt to arrive at a visually pleasing result. Accordingly, there is a significant need for improved font editors and associated tools to assist in the creation and customization of new fonts.

### SUMMARY

Various embodiments are generally related to techniques to automatically create, localize and personalize composite fonts for presentation by an electronic system. A composite font combines characters (or glyphs) from two or more font typefaces. Creating a composite font is typically a manually intensive process. Embodiments implement one or more artificial intelligence (AI) and machine learning (ML) techniques to automatically recommend fonts and font properties suitable for creating a composite font. An ML model is trained with training data comprising composite fonts previously designed by users. These composite fonts provide a ground truth for which combination of fonts and font adjustments result in a visually appealing sequence of characters. The trained ML model performs inferencing operations to suggest fonts and font properties for a composite font. As a result, the AI and ML techniques automatically generate a composite font by combining characters (or glyphs) from multiple fonts, where the combined characters have visual characteristics that are visually, artistically, and aesthetically pleasing to a human vision system (HVS), while reducing or eliminating manual operations typically used to create composite fonts.

In one embodiment, a composite font editor implements a font recommendation module comprising a first ML model to suggest a combination of multiple fonts suitable for a composite font. For example, the first ML model is a transformer-based architecture suitable for processing sequential information. The first ML model obtains or selects a first font for a first sequence of characters, and it predicts, suggest or recommends a second font for a second sequence of characters that visually matches the first sequence of characters. For example, assume a user selects a first font as a serif font such as Times New Roman. The first ML model suggests a second font to combine with the first font, such as a sans serif font like Arial. The first ML model suggests this combination based on its training on previous composite fonts that used Times New Roman with Arial. The ML model then suggests which font to apply for each character or character sequence in the composite font.

In one embodiment, the composite font editor implements a font property recommendation module comprising a second ML model to suggest an adjustment to a font property for a font of the composite font. For example, the second ML model is a regression-based architecture suitable for processing numerical values. Once the first ML model suggests a given combination of fonts, the second ML model predicts, suggests or recommends an adjustment to one or more properties of the second font so that it visually matches one or more properties of the first font. Examples of font properties include vertical scales, horizontal scales, baselines, centerlines, spacing, and other font properties. For instance, assume a first sequence of characters from a first font has a first baseline of a first height, and a second sequence of characters from a second font has a second baseline of a second height. The second ML model suggests adjusting the first baseline or the second baseline so that the first sequence of characters visually match the second sequence of characters.

In one embodiment, the composite font editor implements a personalization module to personalize suggestions for fonts and font properties based on a location or user history. The first ML model or the second ML model is trained on training data that includes location information for anonymized users. The trained ML model then suggests a font or font property based on location information for a given user. Additionally, or alternatively, the first ML or the second ML model is trained on training data that includes a set of information from user profiles. The trained ML model then suggests a font or font property based on previous choices made by a given user or a class of users (e.g., with similar backgrounds). The latter is particularly advantageous for new users of the composite font editor.

The composite font editor repeats these operations for each character or sequence of characters in the composite font. A user either accepts the suggestions or provides feedback to the ML models to refine the suggestions until the user approves of the composite font. In some cases, the user provides control directives to the composite font editor to make final adjustments to the composite font. The result is creation of a visually and aesthetically appealing composite font.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a font editing application in accordance with one embodiment.

FIG. 2 illustrates a font pre-processor in accordance with one embodiment.

FIG. 3 illustrates a convolutional neural network (CNN) in accordance with one embodiment.

FIG. 4 illustrates a control device for a font editing application in accordance with one embodiment.

FIG. 5 illustrates a graphical user interface (GUI) in accordance with one embodiment.

FIG. 6 illustrates a first embox for a character in accordance with one embodiment.

FIG. 7A illustrates a second embox for a character in accordance with one embodiment.

FIG. 7B illustrates a third embox in accordance with one embodiment.

FIG. 7C illustrates a fourth embox in accordance with one embodiment.

FIG. 8 illustrates a list of font properties in accordance with one embodiment.

FIG. 9 illustrates a logic flow in accordance with one embodiment.

FIG. 10 illustrates a sequence of tokens in accordance with one embodiment.

FIG. 11 illustrates a font-prediction model in accordance with one embodiment.

FIG. 12 illustrates training system in accordance with one embodiment.

FIG. 13 illustrates a logic flow in accordance with one embodiment.

FIG. 14 illustrates a training system in accordance with one embodiment.

FIG. 15 illustrates list of font features in accordance with one embodiment.

FIG. 16 illustrates a graph in accordance with one embodiment.

FIG. 17 illustrates a set of graphs in accordance with one embodiment.

FIG. 18 illustrates an example machine learning model in accordance with one embodiment.

FIG. 19 illustrates a composite font rendering in accordance with one embodiment.

FIG. 20 illustrates a logic flow 2000 in accordance with one embodiment.

FIG. 21 illustrates a system in accordance with one embodiment.

FIG. 22 illustrates an apparatus in accordance with one embodiment.

FIG. 23 illustrates an artificial intelligence architecture in accordance with one embodiment.

FIG. 24 illustrates an artificial neural network in accordance with one embodiment.

FIG. 25 illustrates a computer-readable storage medium in accordance with one embodiment.

FIG. 26 illustrates a computing architecture in accordance with one embodiment.

FIG. 27 illustrates a communications architecture in accordance with one embodiment.

### DETAILED DESCRIPTION

Various embodiments are generally related to techniques to automatically create, localize and personalize composite fonts for presentation by an electronic system. A composite font combines characters (or glyphs) from two or more font typefaces. Embodiments implement one or more AI and ML techniques to automatically recommend fonts and font properties suitable for creating a composite font without user input or with limited user input. Examples of font editing systems and composite font editors suitable for implementing the embodiments disclosed herein include products made by Adobe® Inc., San Jose, California, such as Adobe Illustrator®, Adobe InDesign®, and other products made by Adobe Inc. However, embodiments are not limited to a particular font editing system.

Manually designing and creating a new composite font using a conventional composite font editor is a tedious, time-consuming and error-prone process. In some cases, it takes a user hours to develop a single composite font. This is because the user first needs to settle on a font for a particular section of Unicode. Unicode is a computing industry standard for the consistent encoding, representation, and handling of text expressed in most of the world's writing systems. It allows almost any character from any written language to be accurately represented and understood by computers. The user then iterates this process for each section, and then carefully adjusts the preview to set up vertical and horizontal scales, baselines, and other font properties. For example, a user interacts with a graphical user interface (GUI) for the composite font editor to select a base font. The base font is the primary font for the composite font. The user then substitutes individual glyphs or ranges of glyphs of the base font with those from other fonts. The user then defines character ranges to assign to the different fonts. For example, a user might assign all Latin characters to one font, all Greek characters to a second font, and all Cyrillic characters to a third font. For each character range, the user assigns a different font. This font will be used for all characters within that range. In some cases, the user could even assign different styles of the same font to different character ranges.

The user then manually adjusts various font properties or characteristics for each font, sometimes on a character by character basis, to create a uniform appearance for the composite font. Examples of font properties or characteristics for a font include a size, height, weight, spacing, kerning, special characters and ligatures, font metrics, and a host of others. For example, a glyph for one font has a base line, size, vertical size or horizontal size that is different from a glyph for another font. For a composite font, the user must manually adjust these visual properties to harmonize the visual properties of each glyph from each font. If one glyph from one font has a higher base line and a next glyph from another font has a lower base line, the sequence of glyphs will appear higher or lower depending on the font. Once all of the character ranges and fonts are assigned, the user can save and export the composite font as a font mapping file that references all of the base fonts used by the composite font.

To solve these and other challenges, various embodiments include a novel composite font editor to improve creation and personalization of composite fonts. The composite font editor comprises a general set of tools or features to assist a user in manually creating a composite font. In addition, the composite font editor includes a new set of tools or features to automatically create a composite font for a user.

In one embodiment, for example, the composite font editor comprises a font recommendation module, a font property recommendation module, and a personalization module. The font recommendation module implements a ML model trained to recommend fonts for a composite font. The font property recommendation module implements a ML model trained to recommend font properties for a font of a composite font. The personalization module personalizes the recommendations for a given user based on user information, such as a user profile, a class of users, a user history, a user location, a user behavior, and other user information. The composite font editor uses all three modules in an iterative manner to build a composite font, where the composite font comprises a set of characters or glyphs selected from a set of characters or glyphs for different fonts, a given Unicode region or Unicode category.

In one embodiment, the composite font editor implements a font recommendation module comprising a first ML model to suggest a combination of multiple fonts suitable for a composite font. For example, the first ML model is a transformer-based architecture suitable for processing sequential information. The first ML model obtains or selects a first font for a first sequence of characters, and it recommends (or predicts) a second font for a second sequence of characters that visually matches the first sequence of characters. In one embodiment, for example, a method includes receiving an input font sequence comprising font embeddings for a first font and sequence information for the first font, the font embeddings comprising numerical vectors, predicting a second font based on the font embeddings of the first font and the sequence information for the first font using a transformer-based machine learning model, selecting a character from the second font, and adding the character of the second font to a character of the first font to generate a set of characters for a composite font.

An example for the first ML model is a transformer-based convolutional neural network (CNN), among other types of artificial neural networks (ANNs). The first ML model is trained to model the creation of a composite font as a sequential process, using tokens representing fonts that enable the generation of the appropriate combination of Unicode categories. In one embodiment, for example, the Unicode categories include Base, Kana, Punctuation, Full Width Symbols, Half Width Symbols, and Half Width Numerals. The tokens are activated in a consecutive manner. By way of example operations, the ML model accepts as input a first font for a composite font and outputs a suggestion for a second font suitable for the composite font. A training system performs supervised learning to train the ML model on actual or synthetic training data from millions of composite fonts manually designed by users. The training data represents subjective decisions by users on a combination of fonts that are aesthetically and visual pleasing to a user. The trained ML model then performs inferencing operations to classify or predict a second font that is visually compatible with a first font.

The first ML model comprises two parts, including a font-to-embedding model and a transformer architecture. The font-to-embedding model is responsible for converting fonts into meaningful font embeddings. In one embodiment, for example, the font-to-embedding model is based on a pre-trained model, such as Adobe DeepFront, among other types of pre-trained models. The font-to-embedding model receives as input a font, converts the font into a font embedding, and outputs the font embedding to a transformer architecture. The transformer architecture is a powerful sequence modeling framework that has been widely successful in various natural language processing tasks. In this context, the transformer is adapted to handle font embeddings as input and predict the next token (e.g., font) in a sequence. The input to the transformer comprises a sequence of tokens, including a start token, followed by the font embeddings, and padded with padding tokens. The output of the transformer is the predicted next token in the sequence.

In one embodiment, the composite font editor implements a font property recommendation module comprising a second ML model to suggest an adjustment to a font property for a font of the composite font. For example, the second ML model is a regression-based architecture suitable for processing numerical values. Once the first ML model suggests a given combination of fonts, the second ML model recommends (or predicts) an adjustment to one or more properties of the second font so that it visually matches one or more properties of the first font. Examples of font properties include vertical scales, horizontal scales, baselines, centerlines, spacing, and other font properties.

In some embodiments, the second ML model is different from the first ML model. Where the first ML model needs to capture and process sequential information, the second ML model primarily operates on numerical values. Sequential information is not crucial to predict font properties. While it is possible to use the first ML model to predict font properties, transformers tend to require a large amount of training data to generalize effectively. Further, transformers are potentially susceptible to overfitting, thereby causing a transformer to become too specialized to a particular set of training values and therefore performs poorly when presented with new data. Consequently, the second ML model is implemented using a multilayer perceptron (MLP) regression model, which is a class of feedforward ANNs. An MLP comprises at least three layers of nodes: an input layer, a hidden layer, and an output layer. Except for the input nodes, each node is a neuron (or perceptron) that uses a nonlinear activation function. The use of a MLP regression model mitigates the risk of overfitting and ensures more robust inferencing results.

In one embodiment, the composite font editor implements a personalization module to personalize suggestions for fonts and font properties based on a location or user history. For example, the transformer of the first ML model is modified to become a personalized transformer. The transformer of the first ML model is trained on training data that includes location information for anonymized users. The trained ML model then suggests a font or font property based on location information for a given user. Additionally, or alternatively, the first ML model is trained on training data that includes a set of information from user profiles. The trained ML model then suggests a font or font property based on previous choices made by a given user or a class of users (e.g., with similar backgrounds). The latter is particularly advantageous for new users of the composite font editor.

The personalized transformer model enhances creation of composite fonts by adapting it to individual preferences and regional variations. Subjecting the font properties to regression modeling ensures visually pleasing results. Each Unicode bucket font is evaluated against the base font, thereby enabling high-quality visual rendering. In one embodiment, the transformer architecture of the ML model takes advantage of Adobe DeepFont for font embedding as a token, facilitating the seamless expansion of fonts to Adobe Fonts library. This approach simplifies the process of incorporating new fonts into a font editing system. By incorporating local information and user information into the transformer model, the personalized transformer model can predict fonts based on user preferences and cultural context. This can lead to more relevant and tailored predictions, enhancing the user experience and recommendation quality in a given modal dialog scenario.

Embodiments provide several advantages over conventional composite font editors. For example, creating a composite font using conventional editors is a manually intensive process that frequently involves manipulating non-intuitive GUI elements on a trial-and-error basis. Embodiments implement one or more ML models that enable faster designing and creation of composite fonts. In some cases, the ML models can generate a composite font with limited user input, such as a user simply activating a single GUI element to create the composite font or selecting a base font for the composite font. The ML models are trained for creation of the composite fonts using tokens that enable the generation of the appropriate combination of Unicode categories, improving the selection of the fonts for each section. Further, the ML models incorporate personalization and localization-aware tokens. As such, the ML models can adapt creation of composite fonts according to the individual preferences and/or location of the particular user creating the composite font. In addition, the ML models suggest font properties subjected to regression modeling to ensure visually pleasing results across all character sequences of the composite font. The ML models exploit the inter-relationship between two different primary script fonts in a creation workflow and suggests font attribute properties (e.g., scale, size, baseline, etc.) for improved visual aesthetics of the text. Consequently, the ML models facilitate seamless creation and modification of composite fonts, expanding a font library for composite fonts, and also promote adoption of particular composite fonts. As a result, the composite font editor helps in faster convergence and iteration of composite creation workflow, thereby allowing a user to quickly and easily design, create and generate a new composite font from two or more other fonts, while reducing or eliminating manual adjustments required by the user. Accordingly, the embodiments save computer and network resources (e.g., compute, memory, bandwidth, etc.) needed for creating composite fonts while providing a superior user experience and visually pleasing results. Embodiments provide other technical advantages as well.

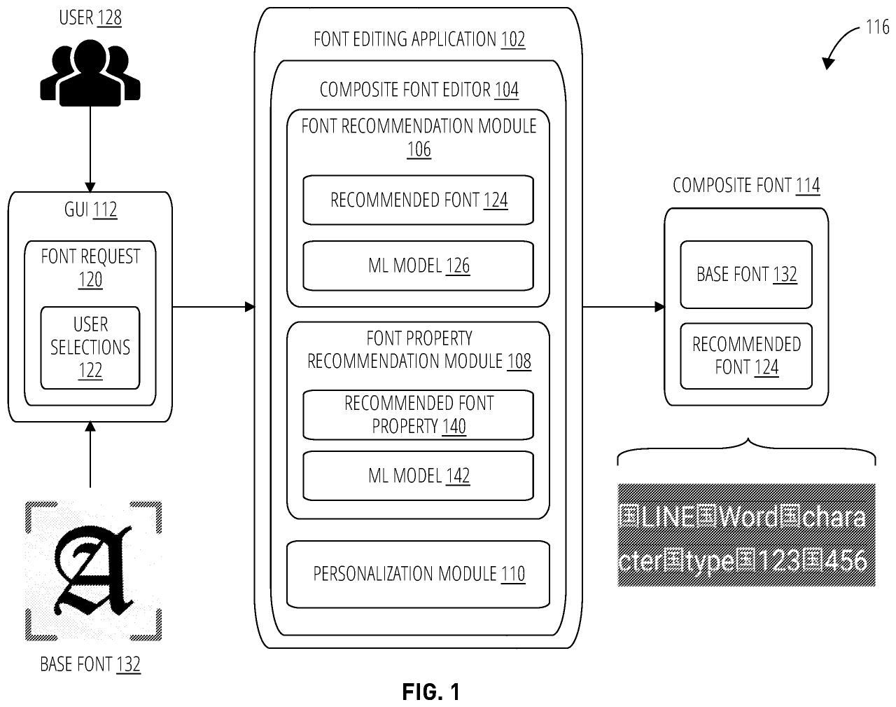

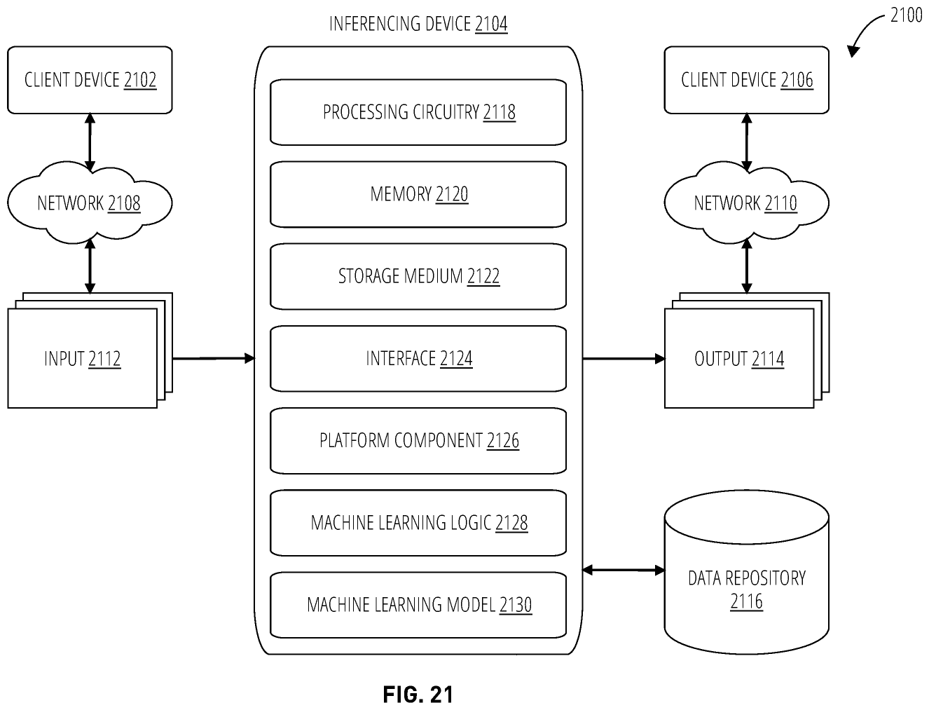

FIG. 1 illustrates an apparatus 116. The apparatus 116 is an example of an apparatus suitable for implementation of certain embodiments as described herein. In various embodiments, the apparatus 116 is suitable for implementation by a font editing system, such as Adobe Illustrator or Adobe InDesign, for example. An electronic device implements the apparatus 116 to perform font editing operations. The electronic device is either a client device, a server device, or a combination of a client device and a server device. An example of a font editing system that includes a client device and a server device is further described in relation to FIG. 21.

As depicted in FIG. 1, the apparatus 116 includes a font editing application 102 to create or modify a font. A font comprises a set of characters, including letters, numbers, symbols, and punctuation marks. Each character is designed with specific shapes, sizes, weights, and styles, collectively giving the font its unique appearance. The font editing application 102 provides a set of font editing tools to create or modify a font. A user 128 uses an input device to manipulate a graphic user interface (GUI) such as a GUI 112. The GUI 112 provides a set of font editing tools that allow the users 128 to design individual characters from scratch or by modifying existing ones. The font editing tools allow the user 128 to adjust attributes for each character (e.g., a shape, size, weight, etc.), adjust a space between characters (kerning) and lines (leading) which can greatly affect the readability and aesthetics of the text, adjust font metrics (e.g., ascent, descent, advance width, and line height) of the font to help ensure that the font displays properly across different systems, support OpenType features (e.g., ligatures, alternate characters, and other special glyphs), convert between different formats (e.g., TrueType (.ttf), OpenType (.otf), PostScript (.ps), and others), provide options to preview fonts in use and to test them across a variety of systems and applications, and other font editing tools.

The visual appearance of characters typically vary according to a particular font. As such, a character in a given font is typically referred to as a “glyph.” A glyph is a specific form of a character in a particular font. In typography, it refers to the visual representation of a character, such as a letter, number, or symbol. For example, the letter “A” in Times New Roman and Arial are two different glyphs. The concept of glyphs is not limited to letters or numbers. It can also encompass diacritical marks, ligatures, or any other visual elements that might be part of a typeface. The notion of glyphs becomes particularly important in non-Latin scripts, where the form of a character can change significantly depending on its context. For example, in Arabic script, a letter can have up to four different glyph forms depending on its position in a word (e.g., initial, middle, end, or isolated), and the same letter is represented by different glyphs in different fonts. Therefore, in a font, each character is represented by a specific glyph, and the collection of all glyphs used in a font is known as a glyph set. This glyph set can include different versions of the same character, including variations for different sizes, weights, and styles.

The font editing application 102 includes a composite font editor 104 to create or modify a composite font 114. The composite font editor 104 creates or modifies one or more composite fonts 114. A composite font 114 is a type of font that combines glyphs from several different fonts. In a composite font 114, different character sets are assigned to different fonts. A composite font 114 allows a single font file to support multiple scripts and character sets, such as Latin, Greek, Cyrillic, Arabic, Japanese, Chinese, Korean, and so forth. Composite fonts 114 are often used in multilingual contexts and when typesetting complex documents that require a wide variety of characters. The composite font format is especially useful for Chinese-Japanese-Korean (CJK) users, because it allows for customization of font properties for specific Unicode sections, such as Kana, Punctuation, Full Width Symbol, Half-Width Symbol, and Half Width Numerals. The composite fonts 114 are typically defined in font mapping files. A font mapping file indicates which base fonts and encoding vectors are used for each character range in the composite font 114.

In one embodiment, for example, a user 128 interacts with a GUI 112 of the font editing application 102 to access a set of tools for generating the composite font 114. The user 128 selects a GUI element, such as a GUI button, that when activated generates a font request 120 to generate the composite font 114. In some cases, the font request 120 includes one or more user selections 122. Examples of user selections 122 include a font, a font type, a font style, a font class, a font property, a language, a location, user profile information, and so forth. In other cases, the font request 120 does not include any user selections 122.

The composite font editor 104 operates to generate a composite font 114 from multiple font typefaces, such as a base font 132 and a recommended font 124. In one embodiment, for example, the font request 120 includes a selection of a base font 132, or a class type for the base font 132, as one of the user selections 122. The base font 132 is the primary font for the composite font 114. In this case, the composite font editor 104 suggests, recommends or predicts a recommended font 124 that is suitable for pairing with the base font 132. In one embodiment, for example, the font request 120 does not include any user selections 122, including a base font 132. In this case, the composite font editor 104 suggests, recommends or predicts a suitable font pairing that includes both a base font 132 and a recommended font 124.

The composite font editor 104 receives the font request 120 and the user selections 122. Assume the case where the user selections 122 include the base font 132. The composite font editor 104 includes a font recommendation module 106 that uses an ML model 126 to predict a recommended font 124 suitable for pairing with the base font 132 to create the composite font 114. In one embodiment, for example, the ML model 126 is a transformer-based CNN. The ML model 126 is trained on training data that includes real-world and synthetic data representing a database of previously created composite fonts. The user 128 either selects the recommended font 124 for the composite font 114, or alternatively, the user 128 interacts with the GUI 112 to receive a different recommended font 124 for the composite font 114.

Once the user 128 selects an acceptable recommended font 124, the composite font editor 104 automatically begins generation of a composite font 114 comprising glyphs from the base font 132 and the recommended font 124. The ML model 126 predicts either the base font 132 or the recommended font 124 for each glyph or glyph sequence in the composite font 114 based on previous glyphs and/or previous fonts in the sequence of glyphs. In this manner, the composite font editor 104 uses the ML model 126 to build a glyph sequence for the composite font 114 on a glyph or glyph range basis for the composite font 114.

To ensure a smooth and harmonious generation of a glyph sequence for the composite font 114, the composite font editor 104 includes a font property recommendation module 108 that uses a second ML model 142 to predict one or more recommended font properties 140 for the base font 132 and/or the recommended font 124. In one embodiment, the ML model 142 is a MLP regression model. The ML model 142 is trained on training data that includes real-world and synthetic data from a database of font properties for previously created composite fonts. The user either selects the recommended font property 140 for the composite font 114, or alternatively, the user 128 interacts with the GUI 112 to receive a different recommended font property 140 for the composite font 114.

Once the user 128 selects a base font 132, a recommended font 124, and at least one recommended font property 140, the composite font editor 104 initiates generation of the composite font 114. When generating the composite font 114, the composite font editor 104 substitutes individual glyphs or ranges of glyphs of the base font 132 with those from the recommended font 124. All characters not explicitly assigned to the recommended font 124 will use the base font 132. The composite font editor 104 then defines character ranges to assign to the different fonts. For example, the composite font editor 104 assigns a character or character range to the base font 132, and another character or character range to the recommended font 124. Each range will specify the starting and ending character for that range, based on their Unicode values or other identifying codes. For each character range, the composite font editor 104 assigns either the base font 132 or the recommended font 124. This font is used for all characters within that range.

The composite font editor 104 further includes a personalization module 110. The personalization module 110 is operable to personalize recommendations for the recommended font 124 or the recommended font property 140 based on personal information for a user, such as a location for the user or a user history. For example, the transformer of the ML model 126 is modified to become a personalized transformer. The ML model 126 is trained on training data that includes location information for anonymized users. The trained ML model 126 then suggests a font based on location information for a given user. Additionally, or alternatively, the ML model 126 is trained on training data that includes a set of information from user profiles. The trained ML model 126 then suggests a font based on previous choices made by a given user or a class of users (e.g., with similar backgrounds).

Once the composite font editor 104 finishes generation of the composite font 114, it outputs the composite font 114 with a combination of characters or glyphs from the base font 132 and the recommended font 124. The composite font editor 104 modifies or adjust one or more font properties, such as from the recommended font property 140, for each glyph in the glyph sequence to ensure that the composite font 114 results in a uniform appearance across all glyphs in the composite font 114 for an aesthetically and visually pleasing effect.

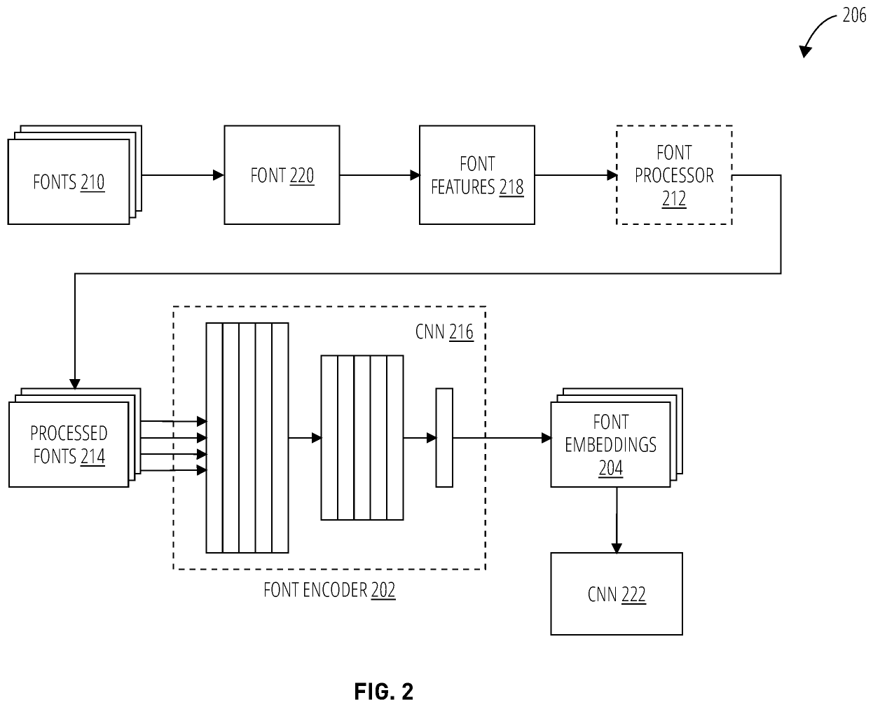

FIG. 2 illustrates a font pre-processor 206 suitable for implementation as part of the font editing application 102. The font pre-processor 206 shows an example of a font-to-embedding model for converting a selected font into font embeddings. The font pre-processor 206 takes as input a set of fonts 210 and outputs a set of font embeddings 204 for the set of fonts 210. The font pre-processor 206 operates either in an online phase or an offline phase to generate the font embeddings 204.

In one embodiment, for example, each of the font embeddings 204 is a vector or numerical representation for a font 220 of the fonts 210. In one embodiment, the vector is a fixed-length numerical representation of a font or an image of a font that captures its visual features and characteristics in a high-dimensional vector space. The fixed-length is typically determined by the architecture of the CNN used to generate the font embeddings 204.

The font pre-processor 206 receives as input a font 220 from the set of fonts 210 for composite fonts 114. In one embodiment, the fonts 210 are from 6 different class types including a base font, kana font, punctuation font, full width symbols font, half width symbols font, half width numerals font. Other examples of class types include without limitation serif fonts, sans-serif fonts, script fonts, decorative fonts, monospaced fonts, slab serif fonts, blackletter fonts, and so forth. The class types may have characters or glyphs from different languages, such as English, French, Spanish, Chinese, Japanese, Korean and so forth.

Each class type includes a set of associated font properties. The font properties are crucial for ensuring coherent rendering of the fonts. Without proper font properties, inconsistencies such as mismatched baselines or varying Unicode sizes between different fonts can occur, resulting in visually unappealing compositions. In one embodiment, for example, at least 7 font properties are of interest for each class type, including a Baseline, Center Glyph, Class Type, Font Name, Horizontal Scale, Vertical Scale, and Size. The font properties data provides essential information that facilitates consistent and harmonious rendering of the composite fonts. By capturing these properties, issues related to baseline alignment, glyph centering, and appropriate scaling can be addressed, ensuring a visually pleasing and unified appearance.

The font pre-processor 206 selects one or more font features 218 from one or more of the base fonts 132. The font features 218 are quantifiable and measurable characteristics of fonts that can be used as input for ML model 126. The exact features used can vary depending on the specific task and model. In one embodiment, the font features 218 comprise those features relevant to a class type and/or font properties for each class type. In one embodiment, for example, the set of font features 218 include a glyph width, a glyph height, glyph ascender, glyph descender, xHeight, capHeight, unitsPerEm, stem width, average glyph contrast, and stem angle. The font features 218 are described in more detail with reference to FIG. 15. Other examples of font features 218 include without limitation features such as: (1) glyph shapes of individual glyphs (letters, numbers, punctuation marks, etc.) can be described quantitatively using vector outlines or pixel-based representations; (2) font metrics which are quantitative measures like x-height, cap height, ascender height, descender depth, baseline position, and other measures that describe the size and positioning of characters in the font; (3) stroke width which is the width of the strokes used to form characters; (4) serif presence which is whether or not the font includes serifs; (5) kerning and spacing between characters and words (kerning) and between lines of text (leading); (6) aspect ratio which is the height-to-width ratio of characters; and (7) font weight and style which is information about the font weight (e.g., bold, light, regular) and style (e.g., italic, normal). For composite fonts, examples of font features 218 include font properties such as a baseline, a center glyph, a class type, a font name, a horizontal scale, a vertical scale and a size. Embodiments are not limited to a particular set of font features 218.

The ML model 126 and/or the ML model 142 is trained to recognize, generate or suggest fonts and/or font properties based on these and other features. For instance, the ML model 126 is trained to classify fonts into categories based on their features, and the ML model 142 is trained to classify font properties for the classified font based on its training data. The font features 218 are either manually engineered (e.g., explicitly calculated and used as input to the model) or learned automatically from the training data using techniques like deep learning. Automatic feature learning can often capture complex and subtle patterns in the data, but it requires large amounts of data and computational resources. Manual feature engineering can be more efficient and interpretable, but it may not capture all of the complexity in the data.

A font processor 212 optionally processes the base font 132 in preparation for input into the font encoder 202. For example, the font processor 212 performs font processing operations such as removing duplicate fonts or redundant information, enhancing font quality, reducing biases from certain fonts, mapping to a specific font format, mapping to a font in a previously processed font library, and other font processing operations.

A font encoder 202 receives as input the processed fonts 214 and the font features 218. The font encoder 202 passes the font features 218 and the processed fonts 214 through a neural network architecture that includes a set of fully-connected convolutional layers of a CNN 216 for the ML model 126. The font encoder 202 generates font embeddings 204 based on the processed fonts 214. The font embeddings 204 have a certain dimension size. In one embodiment, for example, each of the font embeddings 204 has a dimension size of 768 dimensions. Other dimension sizes can be used as well.

The CNN 216 comprises a body and a head. The body is a part of the CNN 216 that comprises several convolutional and pooling layers (among other neural network layers) that are responsible for extracting features (e.g., defined by the font features 218) from the input data, such as the processed fonts 214. The head is a part of the CNN 216 that takes the features extracted by the body and uses them to make a final decision. The head typically comprises one or more fully connected layers (also known as dense layers), followed by a final output layer. The output layer might have a single node for binary classification tasks, multiple nodes for multi-classification tasks, or even a whole grid of nodes for tasks like object detection or semantic segmentation. In one embodiment, a pre-trained network such as Adobe DeepFont is used for the body as a feature extractor, and a new head is added to make predictions for a new task, which in this case is predicting a next token (e.g., a font) in a sequence of tokens. In this case, the new head is represented by fully connected layers of a CNN 222 for the ML model 142.

In the example depicted in FIG. 2, the last head of the CNN 216 outputs the font embeddings 204. The font embeddings 204 are passed as input to the CNN 222 for the ML model 142. The CNN 222 implements a transformer-based neural network architecture. The transformer architecture is a powerful sequence modeling framework that has been widely successful in various natural language processing tasks. In this context, the CNN 222 is adapted to handle the font embeddings 204 as input and predict the next token in the sequence. The input to the CNN 222 transformer comprises a sequence of tokens, including a start token, followed by the font embeddings, and padded with padding tokens. The output of the CNN 222 is the predicted next token in the sequence.

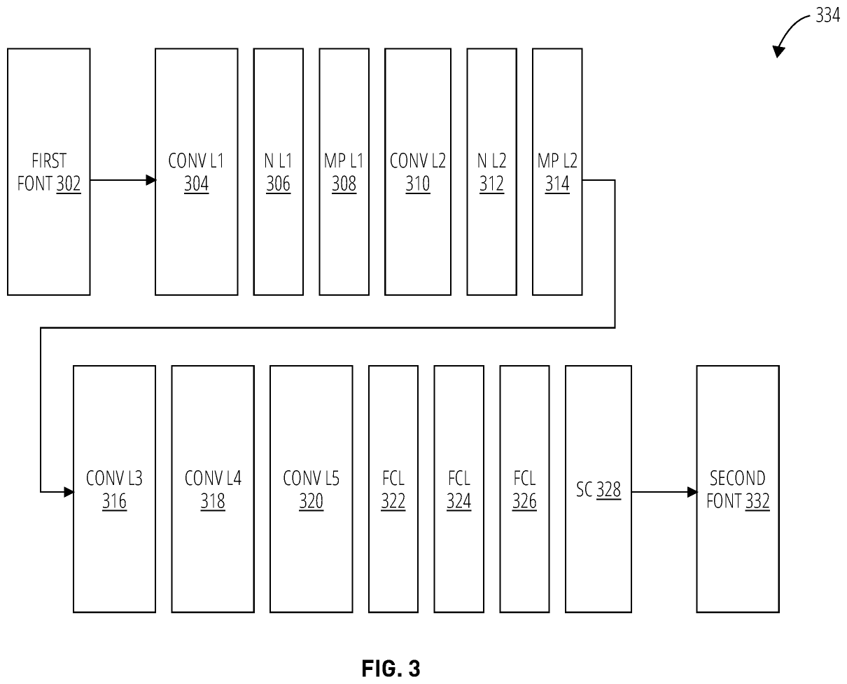

In various embodiments, some or all of the neural network layers for the CNN 216 and the CNN 222 are shared by a single CNN. An example for a shared CNN is further described in relation to FIG. 3.

FIG. 3 illustrates an example of a CNN 334. The CNN 334 implements a neural network architecture that combines neural network layers from one or both of the CNN 216 and/or the CNN 222 of the ML model 126 and the ML model 142, respectively. In one embodiment, for example, the body of the CNN 334 leverages the DeepFont architecture of the CNN 216, where the last head of the CNN 216 is output to a new head trained for predicting a next token (e.g., a font) in a sequence of tokens. However, the neural network layers of the CNN 334 may differ based on a particular implementation. Embodiments are not limited to a particular CNN or CNN architecture.

The CNN architecture for the CNN 334 is further decomposed into two sub-networks: (1) a “shared” low-level sub-network which is learned from a composite set of synthetic and real-world data; and (2) a high-level sub-network that learns a deep classifier from the low-level features. A neural network component facilitates designing and training of the CNN 334. In some embodiments, as depicted in FIG. 3, an exemplary CNN 334 is trained and used to facilitate predicting a next token in a sequence of tokens. In one embodiment, for example, the token represents a font 220, such as the base font 132.

A first stage of the CNN accepts as input a first font 302, and it processes the first font 302 through multiple layers of the CNN 334. In various embodiments, for example, the CNN 334 comprises multiple convolution layers, normalization layers, max pooling layers, and/or SoftMax layers as needed for a given type of font and font features used for each font type. The last stage of the CNN 334 then outputs a classification comprising a second font 332.

The CNN 334 can have multiple layers depending on a number of features used to represent a given font. By way of example, as depicted in FIG. 3, the CNN 334 contains eight layers. The first five layers of the CNN 334 are convolutional layer 1 304, convolutional layer 2 310, convolutional layer 3 316, convolutional layer 4 318 and convolutional layer 5 320. The convolutional layers will learn local patterns through their receptive fields, such as simple shapes and curves that make up different font characters. In some embodiments, rectified linear unit (ReLU) non-linearity is applied to the output of each convolutional and fully connected layer. Normalization layer 1 306 and normalization layer 2 312 are added, in some embodiments, following the first two convolutional layer 1 304 and convolutional layer 2 310, respectively. Similarly, max pooling layer 1 308 and max pooling layer 2 314 are added, in some embodiments, following the first two convolutional layer 1 304 and convolutional layer 2 310, respectively. The pooling layers reduce spatial dimensions (e.g., height and width) while keeping a depth dimension intact, providing a form of translational invariance and reducing the computational complexity for the following layers. The output of the last convolutional layer 5 320 is fed, in some embodiments, to a set of fully connected layers, including the fully connected layer 322, the fully connected layer 324 and the fully connected layer 326. The high-level reasoning in the CNN 334 happens via the fully connected layers. Neurons in each fully connected layer has connections to all activations in the previous layer. The output of the last fully connected layer 326 is fed, in some embodiments, into an N-way SoftMax classifier 328, which produces a probability distribution over N class labels.

In one embodiment, the probability distribution is for N class labels for different fonts, thereby predicting a second font 332 based on the first font 302. As can be appreciated, N represents the number of fonts used to train the CNN. Stochastic gradient descent may be used for optimization, following the convention. Additionally, or alternatively, the learning rate may be reduced by a factor of two after every epoch.

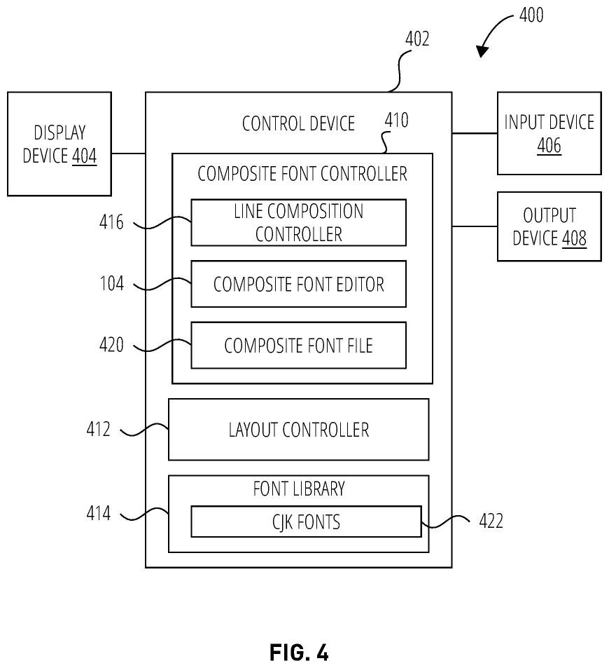

FIG. 4 shows an electronic composition desktop publishing system (DTP) 400 in accordance with one embodiment. The DTP system 400 is suitable for implementing the font editing application 102. The DTP system 400 includes a control device 402 that can execute electronic composition such as layout and editing, a display device 404 that can display data being processed, an input device 406 with which a user can input various types of data such as control instructions, and an output device 408 for outputting processed data, such as a printer device.

To perform composite font operations, the control device 402 includes a composite font controller 410 for controlling composition, a layout controller 412 for layout and editing, and a font library 414 for storing font information that includes attributes of text to be output for display, printing, and so on. In FIG. 4, the font library 414 contains various fonts suitable for the font editing application 102, including one or more CJK fonts 422, which are fonts for ideographic characters such as Japanese, Chinese, Korean (CJK).

The composite font controller 410 includes a line composition controller 416 that arranges within one line characters that are being composed in electronic composition, a composite font editor 104 that creates composite fonts 114 using a plurality of fonts selected from fonts stored in the font library 414, and at least one composite font file 420 that stores a composite font 114 created in this way. In some examples, the composite font file 420 is a composite font library that stores one or more composite fonts 114 previously created and/or edited by the composite font editor 418. The composite font controller 410 may include other components or modules from the font editing application 102 as well.

The display device 404 comprises various display devices such as a liquid crystal display (LCD). The input device 406 comprises a keyboard, a pointing device (mouse, track ball, track pointer, etc.), a scanner, a microphone, a communication interface, or some other suitable input device. The output device 408 comprise a printer, an external memory device, and so on. In one embodiment, the control device 402 includes a processor such as processing circuitry for a central processing unit (CPU) or a graphics processing unit (GPU), memory, network interface, or other platform components commonly found in a smartphone, tablet, notebook computer, desktop computer, workstation, server computer, and so forth. The control device 402 further includes an electronic composition processing program that includes various program routines, such as a composition control routine, layout and editing routine that are loaded into memory and processed by the processor processing circuitry. The control device 402 may also include in whole or in part hardware made into firmware.

In some embodiments, the control device 402 is a DTP processing program, which includes a line composition control routine as the line composition controller 416 that is used in electronic composition. The DTP processing program further includes a composite font editing routine as the composite font editor 104 that combines a plurality of fonts to create composite fonts 114 stored in the composite font file 420. The DTP processing program is stored on non-volatile storage of the DTP system 400 in some embodiments. The DTP processing program is started by a user operating the input device 406 to load the DTP processing program into a volatile memory of the DTP system 400. According to some embodiments, a computer readable storage medium (for example, a disk, a CD-ROM, tape, flash memory, semiconductor memory, etc.) is provided, on which a composite font editing program is stored, the font editing program being operable to convert a general-purpose computer system to a DTP system provided with composite font editing function.

In some embodiments, a composite font editing function is incorporated in the DTP system 400. The composite font editing routine can be started by selecting, by a user, a user-selectable item, say “composite font editing,” shown in a menu via the GUI 112 rendered on the display device 404. It is understood that the user-selectable item may have a different label in other embodiments. It is also understood that instead of a menu, the user-selectable item may be provided in any other manner, such as a button, shortcut, etc. The selection can be performed by clicking, touching, using the keyboard, voice input, or any other user interaction. When the user has text that includes kanji and Roman text in a text frame and the user wants a first font used for the kanji and a second font used for the Roman text to be different, the composite font editor 104 creates a composite font 114 that combines the first font and the second font. When the user selects the user-selectable item, the composite font editing routine is started, and a composite font editing dialog box is displayed on the display device 404.

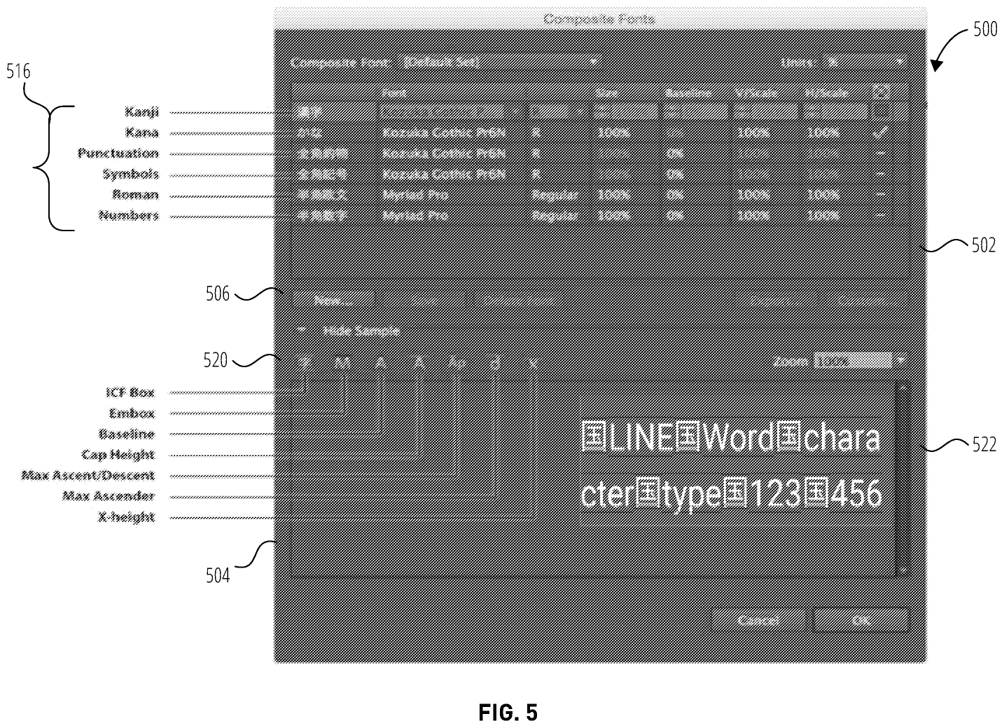

FIG. 5 shows a user-interface 500 or a portion thereof displayed via the display device 404 during DTP processing in the DTP system 400. Specifically, FIG. 5 shows a situation in which a user initiates creation of a new composite font. The user-interface 500 may be displayed in response to a user selecting to create the new composite font. In some embodiments, the user may select to create the new composite font via a menu presented on the GUI 112.

In the example shown in FIG. 5, most of the top half of the composite font creating/editing user-interface 500 is the composite font editing region 502, and most of the lower half is a sample window 504 for displaying sample text in a composite font. Further, the user-interface 500 includes elements 506 to perform one or more operations associated with the composite font. It is understood that the illustrated user-interface 500 is an example and that in other embodiments the user-interface 500 may have additional, fewer, and different portions. In other embodiments, the user-interface 500 may look different from the depicted example.

The elements 506 can provide operations including creating a new composite font 114, saving a composite font 114 to the font library 414, deleting a composite font 114, exporting a composite font 114, and customizing a composite font 114. Exporting the composite font 114 enables the user to store the composite font 114 in the form of a digital file that may be subsequently used on a different DTP system 400. Customizing a composite font 114 enables the user to edit an existing composite font 114 from the font library 414 in some embodiments. It is understood that in other embodiments, the elements 506 may provide additional, fewer, or different composite font operations.

The composite font editing region 502 facilitates the user to enter a name of the composite font 114 to be created via a user-interface element 512. In some embodiments, the composite font 114 is stored as the composite font file 420. In some embodiments, the composite font file 420 is stored with the same name provided via a suitable user-interface element, such as “NewFont.” The composite font editing region 502 further facilitates the user to select one or more fonts as component-font 516 of the composite font 114. In the illustration, six different fonts are individually selected as the component-font 516 of the composite font. The component-font 516 are shown in this order: “kanji,” “kana,” “full-width punctuation,” “full-width symbols,” “half-width Roman text,” and “half-width numerals.” Additional, fewer, or different number of component-font 516 may be used in other embodiments. In some embodiments, the user selects one or more of the component-font 516 using the input device 406, and selects one of the fonts stored in the font library 414 displayed in a pull-down menu format. In the illustration, Roman is selected, and as a result “Myriad Pro” is shown selected in the “half-width Roman text” section. The other component-font 516 are selected in a similar manner. The component-font 516 enables generation of the appropriate combination of Unicode categories for the composite font 114 being created.

In addition to capturing the component-fonts 516, associated font properties are logged for each individual component-font 516. These font properties are crucial for ensuring coherent rendering of the fonts. Without proper font properties, inconsistencies such as mismatched baselines or varying Unicode sizes between different fonts can occur, resulting in visually unappealing compositions. In some embodiments, the following font properties are collected for each class type: Baseline, Center Glyph, Class Type, Font Name, Horizontal Scale, Vertical Scale, and Size. Additional, fewer, or different font properties may be collected in other embodiments. The font properties data provides essential information that facilitates consistent and harmonious rendering of the composite fonts. By capturing the font properties, challenges related to baseline alignment, glyph centering, and appropriate scaling can be addressed, ensuring a visually pleasing and unified appearance.

The sample window 504 displays sample text 522 based on the selected component-fonts 516 and corresponding font properties. The user can hide/unhide the sample window 504 in some embodiments. Further, in some embodiments, the user can zoom-in or zoom-out the sample window 504. Further, the sample window 504 includes user-interactive elements 520 for several reference lines. Multiple reference lines are set in digital fonts, for example embox, Ideographic Character Face (ICF) box, baseline, cap height, ascent, descent, ascender, X height, and so on. In various embodiments, the user-interactive elements 520 controls various features such as display/non-display of the upper and lower reference lines of an ICF box, display/non-display of the upper and lower reference lines of an embox, display/non-display of the baseline, display/non-display of the cap height, display/non-display of the ascent/descent, display/non-display of the descender, and display/non-display of the X height. When the user clicks on any of these elements, the corresponding reference line is displayed in the sample window 504 in a preset color. Furthermore, in this implementation, the element 518a for an ICF box is selected for display, so only the upper and lower reference lines of ICF boxes for kanji fonts are displayed across all the sample text.

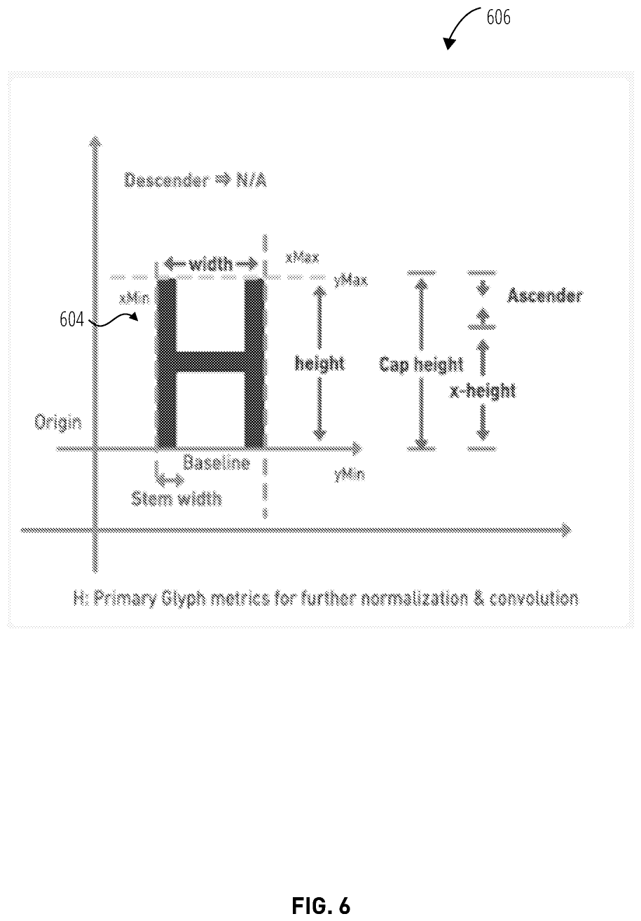

FIG. 6 depicts an example of a glyph 606 representing a character from a component-font 516 with font properties that can be configured using the user-interactive elements 520. It is understood that font properties of characters other than the character “H” can be adjusted, and that the depicted font properties are for example.

The sample window 504 provides visual feedback regarding the reference lines, so the user can use the sample window 504 to check on the relative positional relationships of the baselines of each component-font 516 of the composite font, and the difficulty of checking in the electronic document after stopping the composite font editor is eliminated. When the baseline position is changed, this is immediately reflected in visual feedback in the sample window 504. Therefore, the user can immediately decide whether or not the position of a modified baseline is at the desired position in the sample window, and if it is not as desired, it is possible to change the baseline position again.

As depicted in FIG. 6, the character “H” has an embox 604. An “em box” or “em square” is a term used in typography. It is a square box that is typically used as the basic unit of measurement in font design because of its relative and scalable size. The term “em” originally comes from the letter ‘M’ in the Latin alphabet, as ‘M’ was traditionally as wide as the type size. In digital typography, the em box is typically the design space or grid used to create glyphs for a font. Its height is the intended distance between lines of type in the same type size. The ratio of character dimensions, stroke width, etc., in relation to the em box is what gives a typeface its design properties. The glyphs are usually designed to fit within the em box, but it's not a strict rule; they can extend beyond it. For instance, in a 12-point font, the em box is a 12-point by 12-point square. This provides the basic relative measurement when creating and laying out characters, allowing for consistency in design across different sizes. Even though the em box's size scales with the font size, the relative proportions of the characters remain the same because they're designed in relation to the em box.

The embox 604 used in the depicted example is substantially a square frame, vertically and horizontally demarcated using specific font dimensions (for example, point dimensions). Glyphs for Japanese text are usually arranged in an embox 604 of this type. Therefore, an embox 604 is essentially identical to a virtual body. An embox 604 is usually set in Japanese text fonts, but is sometimes not set in Roman text fonts. In such cases, an embox 604 can be calculated from the Roman text font's bounding box information.

In addition, an ICF box is a face for ideographic characters, also known as “average character face”. If a font has ICF box information, this information should be used, but if a font does not have any ICF box information the ICF box can be calculated by any number of methods.

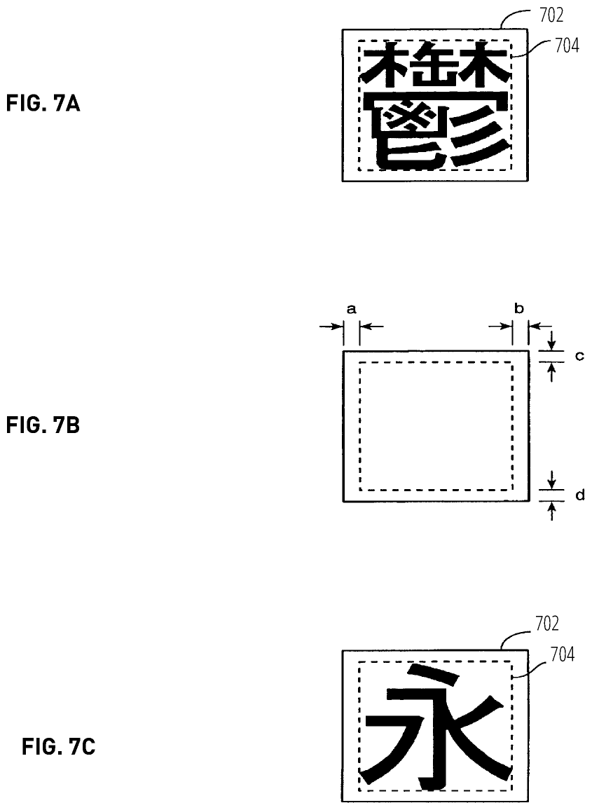

FIG. 7A, FIG. 7B, and FIG. 7C depict calculating an Ideal Character Fascia (ICF) box according to one embodiment. As shown in FIG. 7A, “utsu” is selected as a first reference character, and its embox 702 and bounding box 704 are determined. In addition, as shown in FIG. 7C, “naga” is selected as a second reference character, and its embox 702 and bounding box 704 are determined. Next, as shown in FIG. 7B, the vertical and horizontal differences a, b, c, d, between the bounding box 704 and the embox 702 are determined for each reference character. These eight differences are added and the addition result is divided by 8 to determine the average value of the differences. If a new box is defined by positioning it inside the embox 702 and separated from the embox 702 exactly by the average difference value thus obtained, this box is the ICF box. Furthermore, the ICF box calculation method is not limited only to the method described above. An ICF box can be calculated using only one reference character, and can also be calculated using three or more reference characters. In addition, the reference characters described above are suitable reference characters, but are not limited to these; other characters may also be used as reference characters.

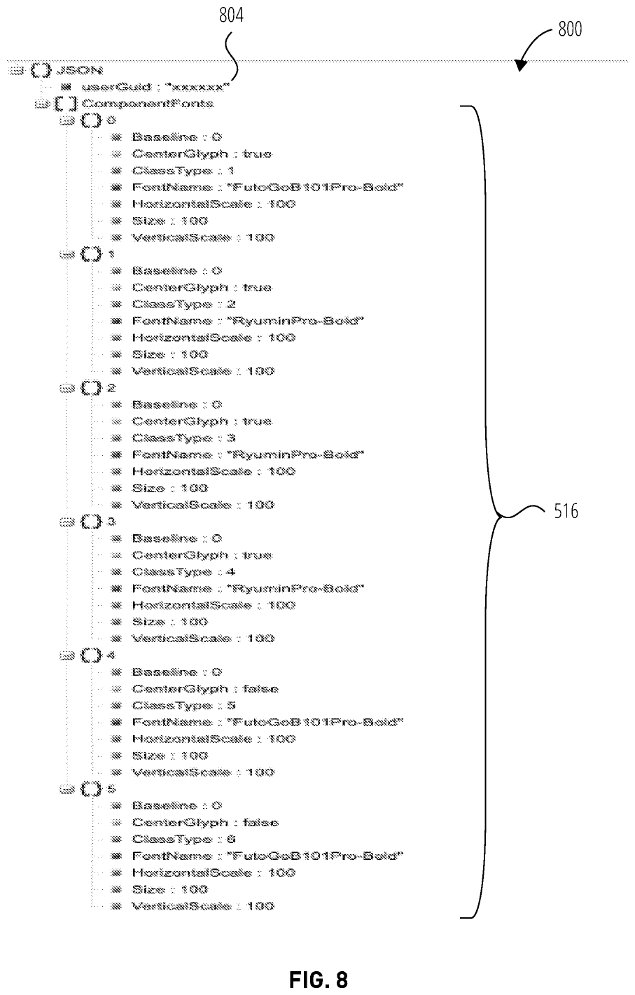

FIG. 8 depicts an example view 800 of a composite font file 420 according to one or more embodiments.

As previously described, each class type for a font 220 includes a set of associated font properties. The font properties are crucial for ensuring coherent rendering of the fonts. Without proper font properties, inconsistencies such as mismatched baselines or varying Unicode sizes between different fonts can occur, resulting in visually unappealing compositions. In one embodiment, for example, at least 7 font properties are of interest for each class type, including a Baseline, Center Glyph, Class Type, Font Name, Horizontal Scale, Vertical Scale, and Size. The font properties data provides essential information that facilitates consistent and harmonious rendering of the composite fonts. By capturing these properties, issues related to baseline alignment, glyph centering, and appropriate scaling can be addressed, ensuring a visually pleasing and unified appearance.

The view 800 depicts the component-fonts 516 added to the composite font. Further, in some embodiments, the composite font 114 includes a user-id 804, which is a unique identifier of the user that created and/or edited the composite font 114. Each component-font 516 is stored with the respective font properties. The component-fonts 516 are enumerated with numerical values from 0 to 5 rather than font names for processing by the ML model 126 and/or the ML model 142. For example, a first font 220 is encoded as number 0, and it includes a Baseline value of 0, a Center Glyph Boolean value of “True”, a Class Type value of 1, a Font Name “FutoGoB101Pro-Bold”, a Horizontal Scale value of 100, a Size value of 100, and a Vertical Scale value of 100.

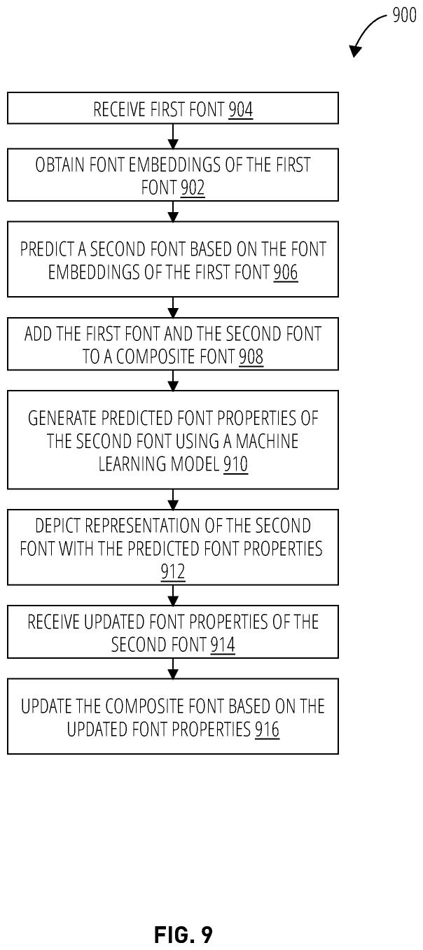

FIG. 9 illustrates an example logic flow 900 for creating and/or editing a composite font according to one or more embodiments. Although the example logic flow 900 depicts a particular sequence of operations, the sequence may be altered without departing from the scope of the present disclosure. For example, some of the operations depicted may be performed in parallel or in a different sequence that does not materially affect the function of the logic flow 900. In other examples, different components of an example device or system that implements the logic flow 900 may perform functions at substantially the same time or in a specific sequence.

The logic flow 900 is described herein after the user has elected to create or edit a composite font. Accordingly, the user may be interacting with the user-interface 500 or any other user-interface to create/edit the composite font. Initially, none of the component-fonts 516 are selected and the sample window 504 may be blank.

According to some examples, at block 902, the logic flow 900 includes receiving a first component-font 516 of the composite font being created. The user provides the first component-font 516 via the composite font editing region 502. In some embodiments, the user configures one or more font properties of the first font. A sample of the first font is depicted in the sample window 504 in some embodiments. The composite font now includes the first component-font 516.

According to some embodiments, the logic flow 900 further includes obtaining font embeddings of the first component-font 516 at block 904. In some embodiments, a font-to-embeddings model 1106 is responsible for converting the selected font into corresponding font embeddings. The font-to-embeddings model 1106 is a pre-trained model trained on a specific task of font classification, such as Adobe DeepFont, among others. In some embodiments, the font embedding are based on several dimensions (e.g., 236, 512, 768, 848, 2424, etc.).

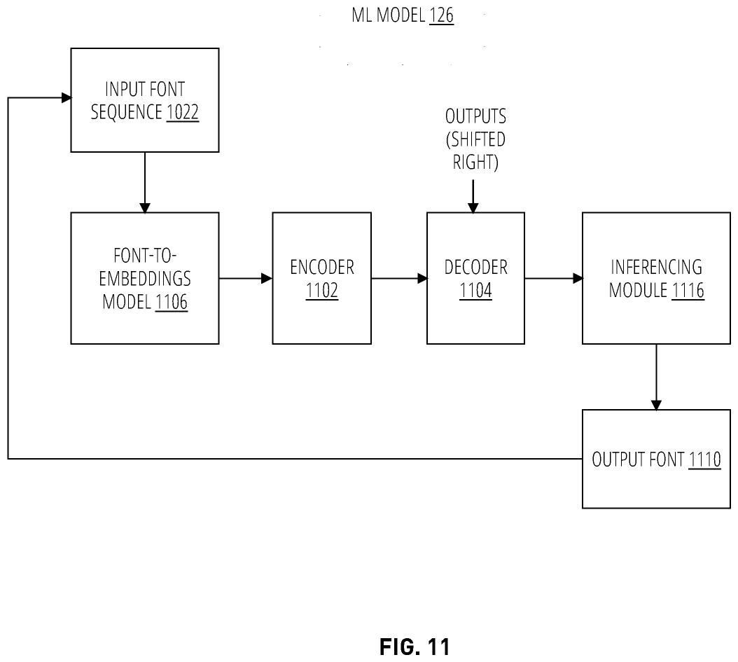

According to some examples, the method includes predicting a second component-font 516 based on the font embeddings of the first component-font 516 at block 906. The prediction is performed using an operating environment 1100 (see FIG. 11), which is a machine learning model that uses the font embeddings obtained from the font-to-embeddings model as input.

According to some examples, the method includes adding the second component-font 516 to the composite font at block 908. Accordingly, the composite font now includes the first component-font 516 provided by the user and the second component-font 516 recommended by the operating environment 1100.

According to some examples, the method includes generating predicted font properties of the second font using a font-property-prediction model, which is a machine learning model, at block 910.

In some embodiments, in response to predicting the second component-font 516, the method includes predicting one or more subsequent component-fonts 516 of the composite font. For example, the third, fourth, fifth, and sixth component-fonts 516 in the example shown in FIG. 5 are predicted and populated in the user-interface 500. The font properties for each of the predicted fonts are also predicted.

According to some examples, the method includes depicting representation of the predicted component-font 516 with the predicted font properties at block 912. The representation is provided in the sample window 504. The user can view and edit any of the font properties according to her/his preference.

According to some examples, the method includes receiving updated font properties of the second font at block 914. The user can edit the font properties using the elements 518a through 518g, the options in the composite font editing region 502, or any other manner. Each of the component-fonts 516 can be updated accordingly.

According to some examples, the method includes updating the composite font based on the updated font properties at block 916. In some embodiments, in response to the user updating the font properties, any subsequent component-fonts 516 of the composite font are re-predicted. The composite font is updated accordingly.

The user can save and store a composite font created in this manner. The created composite font is stored in the font library 414 in some embodiments. The created composite font is stored as a composite font file 420 in some embodiments. The user can choose to save and/or export the composite font as an additional or alternative composite font file 420.

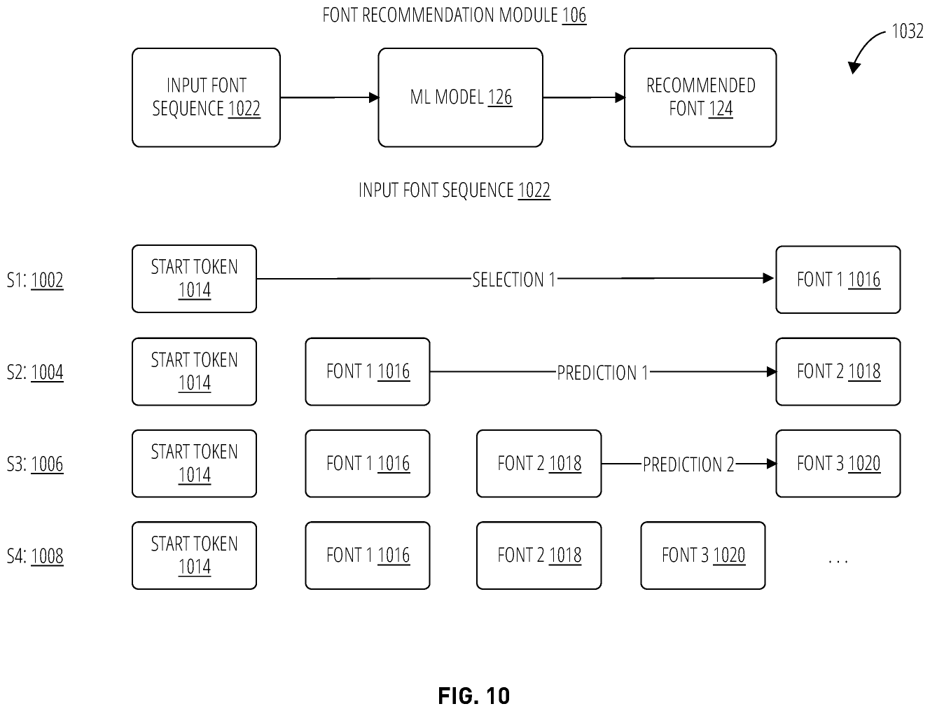

FIG. 10 depicts an operating environment 1100 according to one or more embodiments. The operating environment 1100 visualizes the flow of input and output data, and the sequential nature of the input data, for the font recommendation module 106 of the composite font editor 104 of the font editing application 102.

As depicted in the operating environment 1100, the ML model 126 of the font recommendation module 106 receives as input an input font sequence 1022. The ML model 126 processes the input font sequence 1022, and it outputs a recommended font 124 based on the input font sequence 1022.

The input font sequence 1022 comprises an ordered sequence of tokens representing one or more fonts 210 for a composite font 114. A sequence in mathematics is an ordered list of numbers or elements, where each element is followed by another according to a certain rule. The order of elements is a crucial aspect of a sequence. Each individual number in the sequence is called a “term”, and each term has a position (also called an index or rank), such as 1, 2, 3, . . . , N, where N represents any positive integer. The input font sequence 1022 is an ordered list of terms, where each term is a token representing a font 220 in a composite font 114, and where each token has a position in the ordered list of tokens.

A composite font 114 combines multiple fonts 210. Each font 220 from the multiple fonts 210 is applied to a character (or glyph) or character range (or glyph range) for a section of Unicode in a sequential order. The input font sequence 1022 comprises a sequence of tokens, where each token represents font embeddings 204 for a font 220 in the sequential order, and each token has a position in the ordered list of tokens. For example, assume a first font is applied to a first character or character range in a Unicode sequence, a second font is applied to a second character or character range in the Unicode sequence, a third font is applied to a third character or character range in the Unicode sequence, and so forth. The first font has a first position in the sequence order, the second font has a second position in the sequence order, and the third font has a third position in the sequence order. The input font sequence 1022 comprises vector embeddings for the first font, the second font, and the third font in the sequential order.

The operating environment 1032 provides an example for an input font sequence 1022. In this example, the input font sequence 1022 starts with a start token 1014. In various example stages S1 to S4, the start token 1014 is followed by a series of next tokens predicted by the operating environment 1100. Accordingly, the operating environment 1100 processes previously provided fonts of a composite font 114 and predicts the next font of the composite font 114 based on previous tokens in the input font sequence 1022.

As depicted in FIG. 10, at stage S1: 1002, assume a user selects font 1 1016 as a base font 132. The input font sequence 1022 at S1: 1002 comprises a start token 1014 and the font embeddings 204 for the font 1 1016. In some cases, the input font sequence 1108 includes one or more padding tokens to ensure a uniform input size for the input font sequence 1022.

At stage S2: 1004, the input font sequence 1022 from stage S1: 1002 is fed into the ML model 126, and it outputs a recommended font 124 for the next font in the input font sequence 1022, which is represented as font 2 1018. The predicted font 2 1018 is added to the input font sequence 1022. The input font sequence 1022 at S2: 1004 comprises a start token 1014, font embeddings 204 for the font 1 1016, and font embeddings 204 for the font 2 1018. As with stage S1: 1002, in stage S2: 1004, the input font sequence 1022 may include one or more padding tokens to ensure a uniform input size for the input font sequence 1022.

At stage S3: 1006, the input font sequence 1022 from stage S2: 1004 is fed into the ML model 126, and it outputs a recommended font 124 for the next font in the input font sequence 1022, which is represented as font 3 1020. The predicted font 3 1020 is added to the input font sequence 1022. The input font sequence 1022 at S3: 1006 comprises a start token 1014, font embeddings 204 for the font 1 1016, font embeddings 204 for the font 2 1018, and font embeddings 204 for the font 3 1020. As with stages S1: 1002 and S2: 1004, in stage S3: 1006, the input font sequence 1022 may include one or more padding tokens to ensure a uniform input size for the input font sequence 1022.

At stage S4: 1008, the input font sequence 1022 from stage S3: 1006 is fed into the ML model 126, and it outputs a recommended font 124 for the next font/in the input font sequence 1108, where/represents any positive integer. This process continues until the composite font editor 104 completely generates the composite font 114 across an entire Unicode sequence.

FIG. 11 depicts an example architecture of an ML model 126 according to one or more embodiments. The ML model 126 is based on a transformer architecture, such as described for the CNN 216, the CNN 222 or the CNN 334 with reference to FIG. 2 and FIG. 3. As depicted in FIG. 11, an example ML model 126 includes a font-to-embeddings model 1106, an encoder 1102, a decoder 1104, and an inferencing module 1116.

The transformer architecture facilitates a sequence modeling framework. As described with reference to FIG. 10, the ML model 126 receives as input an input font sequence 1022 comprising an ordered sequence of tokens, where each token represents a font 220 in the composite font 114, in a sequential loop. The output of the ML model 126 is the predicted next token in the sequence. In embodiments described herein, ML model 126 is adapted to use a base font 132 (e.g., the first font 302) and the font embeddings 204 of the base font 132 as the start token 1014. The ML model 126 then predicts an output font 1110 based on the base font 132, which is the next token in the sequence of tokens. Font embeddings 204 for the output font 1110 are added to the input font sequence 1022, which is then fed back into the ML model 126 to predict the next token in the sequence of tokens. The ML model 126 then predicts another output font 1110, which is the next token in the sequence of tokens. Font embeddings 204 for the output font 1110 are added to the input font sequence 1022, which is then fed back into the ML model 126 to predict the next token in the sequence of tokens. The sequential loop continues until the composite font 114 is generated for an entire Unicode sequence.

As noted elsewhere herein, a font-to-embeddings model 1106 receives the input font sequence 1108, and it converts one or more tokens from the input font sequence 1108 into font embeddings 204, such as a token representing the first font 302. The font-to-embeddings model 1106 outputs the font embeddings 204 to the encoder 1102. In some cases, the input font sequence 1108 can comprise a single first font selected by the user, such as the base font 132, for example.

The encoder 1102 encodes the font embeddings 204 with various types of information, such as position information, location information, and/or user profile information. Because the transformer architecture does not inherently encode a position or order of tokens in the sequence, the encoder 1102 encodes sequence information indicating the relative positions of the font embeddings 204 in the input font sequence 1022, allowing the ML model 126 to consider the sequential nature of the data. The encoder 1102 also encodes location information associated with a font for the composite font 114. For example, the location information may indicate a location of a user 128 or a control device 402 used by the user 128. The encoder may also encode user profile information associated with a font for the composite font 114. The user profile information may indicate information about a user 128, such as user preferences, user languages, user history, previous composite fonts 114 created by the user 128, and so forth.

The decoder 1104 decodes various font embeddings 204 and the various types of information about the font embeddings 204, such as the sequence information, for example. The decoder 1104 then passes the decoded information to the inferencing module 1116.

The inferencing module 1116 receives the decoded information as input, and it perform inferencing operations to predict a next token, which is the next font in the sequence of the input font sequence 1022. For example, the inferencing module 1116 predicts a second font 332 based on the first font 302.

In some cases, the inferencing module 1116 uses the sequence information, the location information, or the user profile information to assist in predicting the second font 332. For example, assume the input font sequence 1022 comprises a sequence of three tokens representing font embeddings 204 for three different fonts. The inferencing module 1116 analyzes the three tokens, and the sequential order of the three tokens, to predict the next token as the output font 1110.

For example, assume that the user 128 prefers a repeating pattern for the three fonts when creating a composite font 114 as indicated by the user profile information for the user 128. Based on this information, the inferencing module 1116 analyzes the sequence information and notes that three tokens in the sequence, it selects the first font in the sequence of three fonts as the next token in the sequence of tokens, and it outputs the first token as the output font 1110.

In another example, assume the that the user 128 is from an East Asian country, and the user 128 wants to build a composite font 114 that combines a Latin font and a CJK font in an interleaved pattern. Based on this information, the inferencing module 1116 analyses the sequence information and notes that the there are three tokens in the sequence, with the first token in the Latin font, the second token in the CJK font and the third token in the Latin font. The inferencing module 1116 selects the second font in the sequence of three fonts as the next token in the sequence of token, since it is the CJK font in the interleaved pattern, and it outputs the second token as the output font 1110.

To perform inferencing operations, the font encoder 202 maps the font embeddings 204 to a shared embedding space of the ML model 126. There are a variety of font selection tasks with different goals and requirements. One designer may want to match a certain font type with another font type, such as a Roman Latin font with an Eastern Asian font. Another designer may want to match different fonts within a given font type, such as Times New Roman with Calibri. Yet another designer may want to match different styles for a same font, such as Arial Narrow and Arial Normal, or different fonts, such as Arial Light and Calibri Light.

In one embodiment, the CNN 216 of the ML model 126 is trained to learn measures of font similarity between fonts used for composite fonts, such as the composite font 114. More particularly, the ML model 126 generates font embeddings 204 within a shared embedding space, where font embeddings 204 for fonts used together in a composite font 114 are mapped closer together in the shared embedding space, while font embeddings 204 for fonts not used together in a composite font 114 are mapped farther apart in the shared embedding space. In this case way, similarity measures such as cosine similarity are used to generate similarity scores for each font, and those fonts with the K highest similarity scores are used to infer or suggest font pairings for a given composite font 114. In one embodiment, for example, the first font 302 is converted to a font embedding and is mapped to the shared embedding space having mappings for other fonts that could be potential pairings for a base font and a suggested font to pair with the base font. A similarity score measuring a similarity between the base font and the other fonts is used to select or predict a suggested font for pairing with the base font.

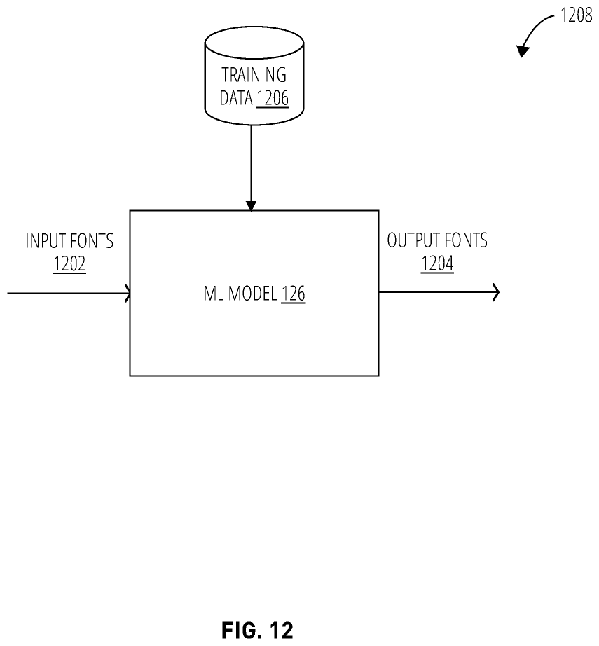

FIG. 12 illustrates a training system 1208 suitable for training the ML model 126. In some embodiments, the training system 1208 trains the ML model 126 in a self-supervised manner using causal language modeling. Accordingly, during training, the ML model 126 is tasked with predicting the next font in a sequence, given the previous n image choices but not the future ones. Therefore, the ML model 126 is trained to learn the internal font modalities and capture the user's interaction patterns.

The ML model 126 is trained using composite fonts 114 from various users of the DTP system 400. It should be noted that the DTP system 400 can have several instances, for example, being used by thousands and millions of users. Each instance of the DTP system 400 may be used by users independently on respective computing devices. One or more users may use and/or create composite fonts, and as such, the respective computing devices of the users may have composite fonts stored in the respective font library 414.

In some embodiments, composite fonts from the users' font library 414 are logged in a central repository that is used as a training data for the operating environment 1100. The logging process records composite fonts available on the user's device in predetermined memory locations associated with the DTP system 400. In some embodiments, the composite font controller 410 enumerates a storage of the computing device at specified locations and lists all the composite fonts. The enumeration can also be used to display a list of the composite fonts in one or more menus in the user-interface 500.

For each composite font 114, as noted elsewhere herein, at least six buckets (component-fonts 516) are logged based on Unicode (also called as class type):
1. Base Font
2. Kana Font
3. Punctuation Font
4. Full Width Symbols Font
5. Half Width Symbols Font
6. Half Width Numerals Font

In addition to capturing the component-fonts 516, associated font properties are logged for each individual component-font 516. At least the following font properties are collected for each component-font 516:
1. Baseline
2. Center Glyph
3. Class Type
4. Font Name
5. Horizontal Scale
6. Vertical Scale
7. Size

Further, to enable personalization a user embedding is added to the transformer architecture. The user embedding is built from a set of information included in a user profile respectively associated with each user of the DTP system 400. In some embodiments, a “user token” is created and appended in the sequence of input tokens provided to the encoder 1102 to enable generating personalized fonts. The user token includes preferences of the user, such as font-faces, font-sizes, etc. The preferences can specify values based on the user's past selections of component-fonts 516.

The user embedding is anonymized in some embodiments. For example, each user is assigned a user-id 804. A user profile for a user is identified only using the user-id 804 so that all personal and sensitive information of the user can be protected and is not shared/used when training and using the machine learning models.

A sample datapoint in the training data captured accordingly is illustrated in FIG. 8. The training dataset obtained from the logging is updated periodically, as new composite fonts are logged, for example, each month, each day, each week, etc. By leveraging the dataset of logged composite fonts and their associated font properties, the operating environment 1100 is trained to generate personalized composite fonts using transformer architecture.

Training of the ML model 126 is performed using techniques used for training a transformer architecture. In some embodiments, before the training of the ML model 126, the logged data is processed to ensure the quality and consistency of the training dataset for effective training. For example, any duplicate entries are removed to ensure that the dataset is free from redundant information, enhancing its quality and reducing biases that may arise from duplicate font entries.

Further, the collected composite font data can include fonts that are not accessible or unavailable for various reasons. This is a technical challenge that prevents the operating environment 1100 from being efficiently trained. To address such a technical challenge, a similarity model based on 1.5 million BYOF fonts is used, to map postscript font names to fonts from a predetermined library of fonts. Accordingly, in case a font is not available to be used, the corresponding matching font is used for the training, thus enabling the training to proceed using the matching data points.

Further, in some embodiments, to incorporate locale information into the ML model 126 for personalization, the ML model 126 is trained as a locale aware ML model 126. Additional operations are performed to train and change ML model 126 architecture to support the locale information.

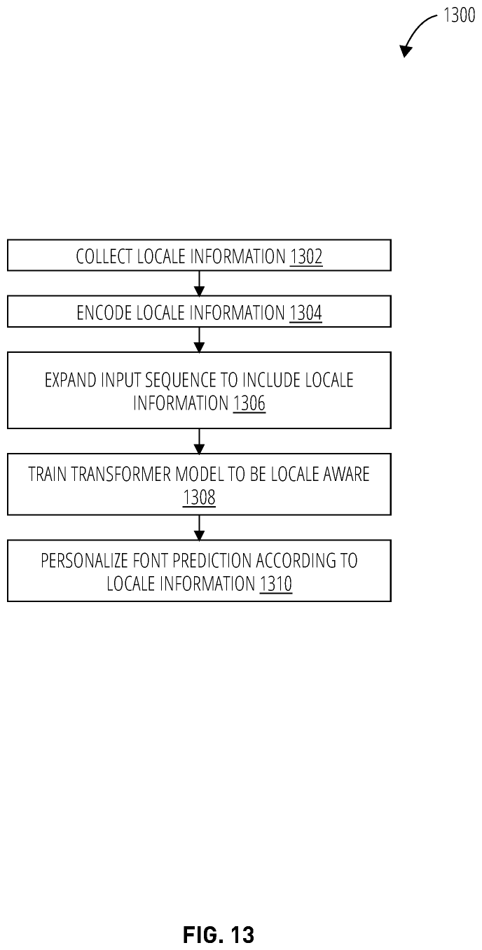

FIG. 13 illustrates an example logic flow 1300 for training and using an ML model 126 that is locale aware according to one or more embodiments. Although the example logic flow 1300 depicts a particular sequence of operations, the sequence may be altered without departing from the scope of the present disclosure. For example, some of the operations depicted may be performed in parallel or in a different sequence that does not materially affect the function of the logic flow 1300. In other examples, different components of an example device or system that implements the logic flow 1300 may perform functions at substantially the same time or in a specific sequence.

According to some examples, the method includes collecting locale information at block 1302. In some embodiments, alongside the composite font information that is logged, the locale information for each anonymized user is also stored in the composite font captured. The user-id 804 facilitates anonymizing the user, and yet associating several composite fonts collected from the same user. The locale information can be captured and stored using alpha-2 representation to log the data, for example, to represent regions as af, al, dz.

According to some examples, the method includes encoding locale information at block 1304. The encoding can be performed using any transformer-based techniques. In some embodiments, the locale information is encoded using a one-hot vector to represent and capture the locale details. Each unique locale value is represented as a binary vector with a length equal to the total number of possible locale values. Accordingly, the vector has a value of 1 at the index corresponding to the specific locale and 0 s everywhere else.

According to some examples, the method includes expanding the input font sequence 1022 to include locale information at block 1306. The input sequence is expanded to include the locale information along with the font embeddings. Accordingly, the input format can be as follows: <start token> <locale embedding> <font1 embedding> <font2 embedding> <pad> <pad> <pad> <end token>. This new input format allows the model to consider both the images of the input font and the corresponding locale information. An input sequence can be: <start token> [0 . . . , 1, 0 0] <font1 embedding> <font2 embedding> <pad> <pad> <pad> <end token>.

According to some examples, the method includes training transformer model to be locale aware at block 1308. The locale-aware operating environment 1100 is trained as a transformer model using the expanded input sequences and the corresponding target tokens. The target tokens are the next token in the sequence after the font and locale information. For example, in the above scenario: <start token> [0 . . . , 1, 00] <font1 embedding> <font2 embedding> <PREDICTED OUTPUT> <pad> <pad> <end token>.

According to some examples, the method includes personalizing font prediction according to locale information at block 1310. During inference, the ML model 126 that is trained accordingly is provided with the initial input sequence containing the <start token>, <locale embedding>, and <font embeddings>. The trained locale aware ML model 126 generates predictions for the next font. The process is repeated to generate a sequence of fonts based on the user's font choices and locale information.

In some embodiments the input sequence further includes the user embedding and/or the user-id 804. Accordingly, the ML model 126 not only generates a locale aware font, but also based on the user's preferences encoded in the user embeddings associated with the user-id 804. The process is repeated to generate a personalized sequence of fonts based on the user's font choices and locale information.

In some embodiments, the user embedding spans across users and rather being mapped to a particular user, the user embedding classifies the user (or user-id 804) into one or more categories of users. Each category can specify particular preferences of fonts. The classification of the user embedding can be machine-learning based in some embodiments. For example, the classification can be based on behavior rather than initial information to cater to proficient users, new users, intermediate users with their preferences more accurately. Accordingly, the user embeddings maps common behaviors across similar users.

By incorporating locale information into the transformer model, embodiments herein enable personalization of fonts predicted for a composite font based on the user's preferences and cultural context. Accordingly, embodiments herein provide more relevant and tailored predictions, enhancing the user experience and recommendation quality in the composite font creation user-interface 500.

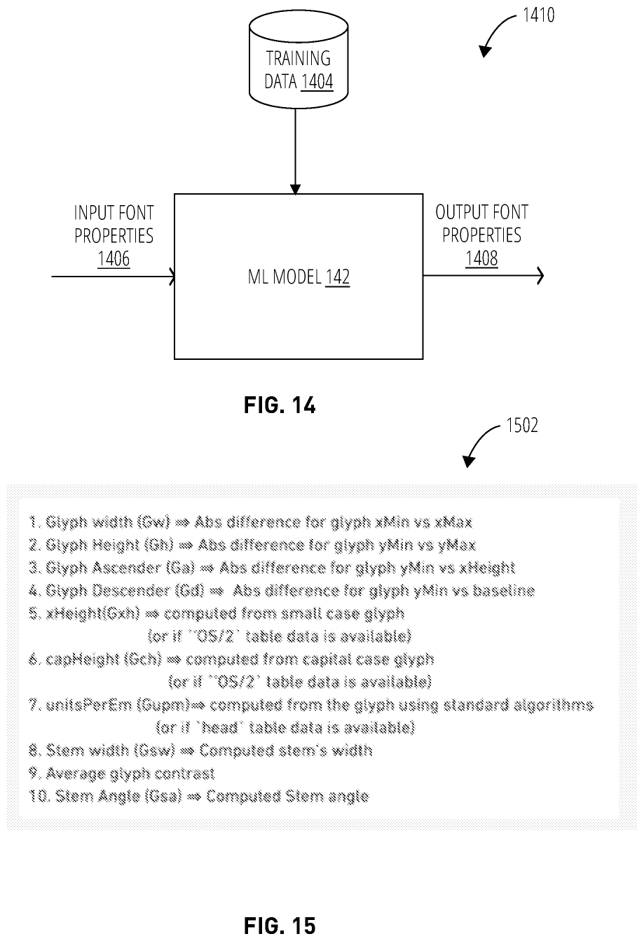

FIG. 14 depicts a training system 1410 for the ML model 142 of the font property recommendation module 108 according to one or more embodiments. The ML model 142 is an example of the CNN 216, CNN 222, or the CNN 334 as described with reference to FIG. 2 and FIG. 3. In one embodiment, for example, the ML model 142 is trained to suggest, recommend or predict recommended font properties 140 for a base font 132 or a suggested font 136 of the composite font 114.

The ML model 142, in some embodiments, is based on a multi-layer perceptron (MLP) regression architecture. A MLP is a type of artificial neural network (ANN). An MLP typically comprises at least three layers of nodes: an input layer, a hidden layer, and an output layer. Each node in one layer connects with a certain weight to every node in the following layer. MLP regression refers to using a multi-layer perceptron for regression tasks. In a regression task, the aim is to predict continuous numeric values as opposed to categorical values. In MLP regression, the neural network is trained to predict a continuous output. This means that the output layer of the network only has one node (for simple regression tasks), and this node is used to output the predicted numeric value. The activation function of this output node is typically linear, meaning that the output of the node is the same as its input. However, for certain types of data, other activation functions like ReLU or sigmoid might be used in the output layer.

Like other machine learning models, MLPs can be trained using various forms of gradient descent and backpropagation to minimize a loss function that measures the difference between the network's predictions and the actual values. The most commonly used loss function for regression tasks is mean squared error (MSE). The power of an MLP lies in its ability to model non-linear relationships between inputs and outputs, and its capacity to learn from a wide range of data. However, they can also be prone to overfitting if not properly regularized, and can be more computationally expensive to train than simpler models.

Compared to the ML model 126, sequential information is not used for predicting font properties. The ML model 142 receives numerical values as input font properties 1406. Transformers typically require a large amount of data to generalize effectively, and hence, struggle to generalize well for the numerical values. Accordingly, training a transformer-based model for font-property-prediction model 1402 could lead to overfitting, where the model becomes too specialized to a particular set of values and performs poorly when presented with new data. Hence, the font-property-prediction model 1402 is implemented as an MLP regression model to mitigate the risk of overfitting and to ensure robust rendering results.

The ML model 142 predicts the values of output font properties 1408 for a predicted component-font 516. The output font properties 1408 can include at least the baseline, center glyph, horizontal scale, vertical scale, and size.

The training system 1410 trains the ML model 142 using regression modeling. In some embodiments, the training system 1410 uses a set of training data 1404 to train the ML model 142, where the training data 1404 includes multiple font embeddings or vectors. The training data 1404 is obtained from the captured composite fonts as described herein from the actual users of the font editing application 102 (see FIG. 8).

Each font property vector includes numerical values representing the font properties, for example, baseline, center glyph, horizontal scale, vertical scale, size. The features for each font vector is based on the font metadata. For example, typefaces may be assumed as ensembles of graphical features and distinctions, such as their width, height. The length of ascender, descender, capHeight and stem width are also included in some embodiments.

Once the training system 1410 trains the ML model 142 using the training data 1404, the trained ML model 142 receives input font properties 1406 as input, and it predicts or suggests one or more font properties for a font in the composite font 114. It then outputs a set of output font properties 1408 as recommended font properties 140 for the composite font 114.

FIG. 15 provides an example list of glyph metrics 1502 that are captured, processed, and normalized during the regression modeling of the font-property-prediction model 1402. The glyph metrics 1502 are captured in terms of horizontal, vertical, and diagonal dimensions. The glyph metrics 1502 facilitate rendering/lay outing differences for a text with the font. Each of the captured glyph metrics 1502 in the font property vector is normalized.

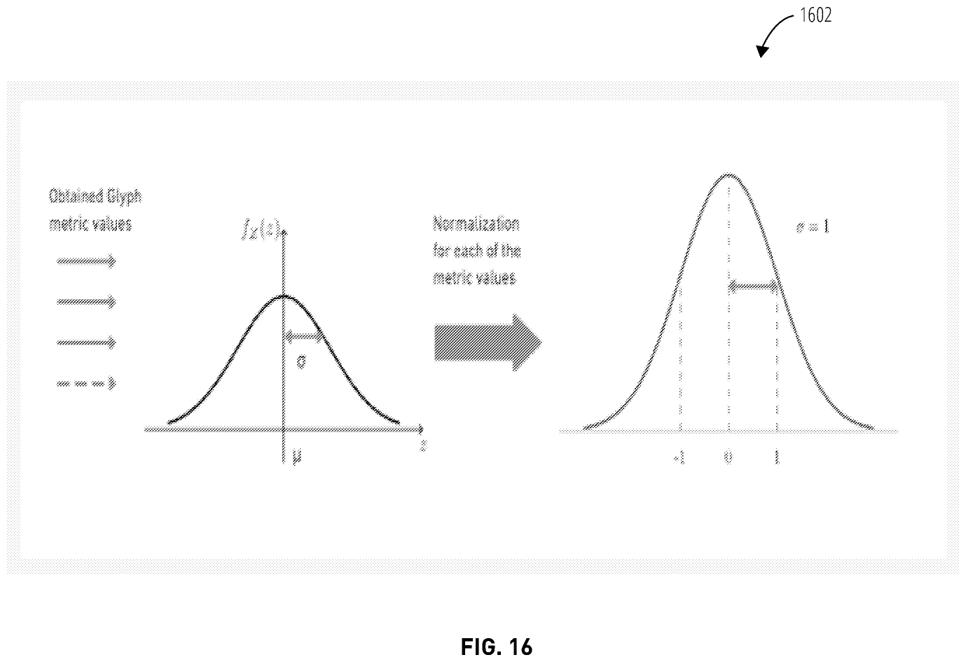

FIG. 16 illustrates a graph 1602 that depicts font glyph attributes z-score normalization using standard deviation. It is understood that the normalization may be performed in any other manner in other embodiments. The normalized data of the features are fed as the training data 1404 when training the font-property-prediction model 1402.

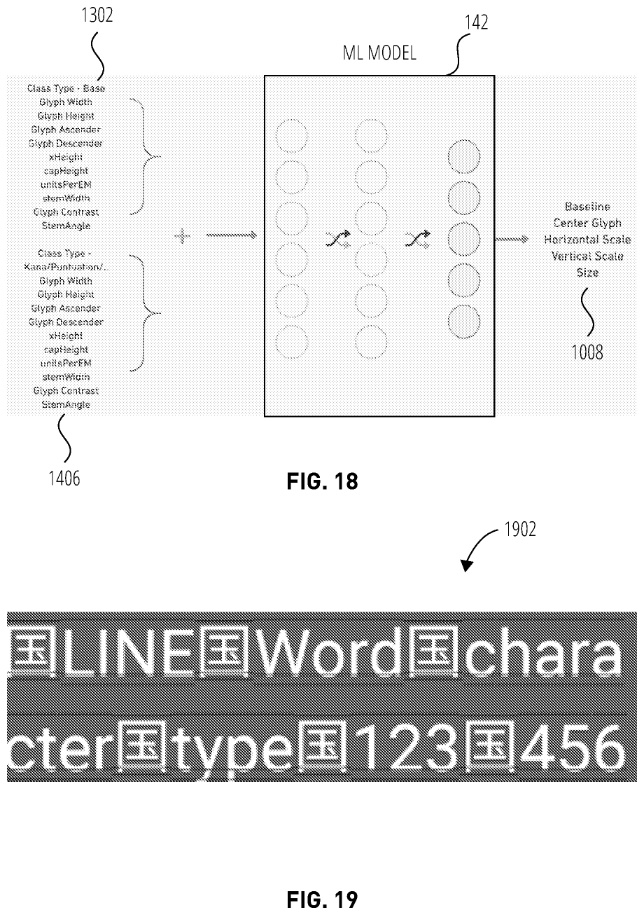

Each font is trained relative to a base font class because there are no changes in the features of the base font, and the predicted font with the predicted font properties is to be rendered optimally in regard to the base font when set in a single text object. Here “base font” is the first font 302 in the composite font 114 that is provided by the user. For example, if each font has different baselines, they will jump baselines if not set without a baseline offset. Accordingly, input font properties 1406 to the font-property-prediction model 1402 include features of base font concatenated with the features of the font to be predicted alongside the class type as shown in FIG. 18.

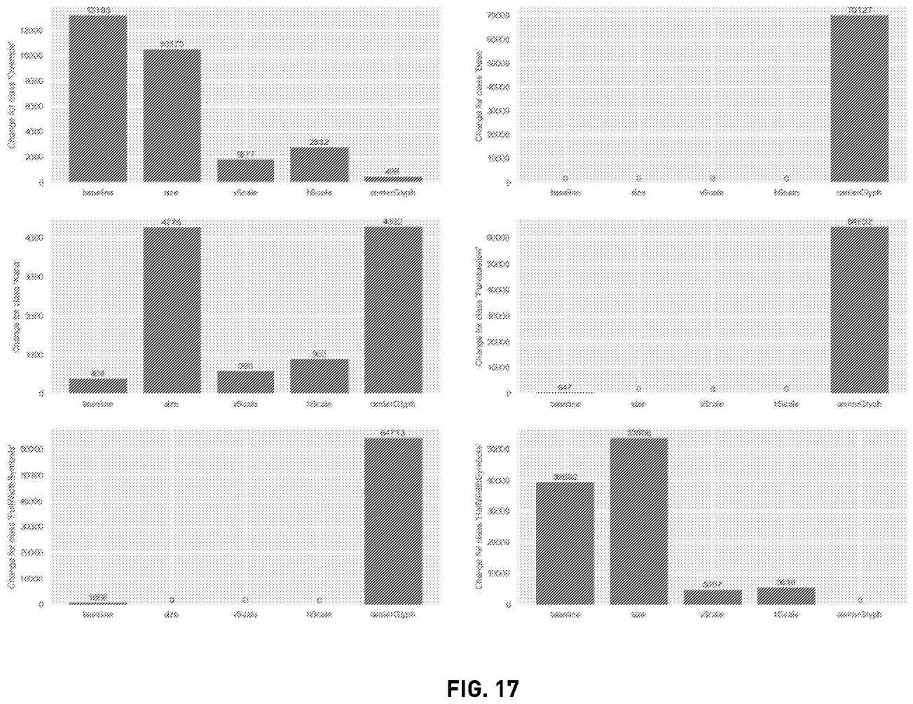

FIG. 17 illustrates a series of graphs that represent a distribution of changes in values for various font properties some of the font class types used by the composite font editor 104. The font properties include a base line, a center glyph, a horizontal scale, a vertical scale, and a size. The graphs plot setting changes for these 5 font properties for a representative set of composite fonts 114 used as part of the training data 1404. The font property values from the representative set of composite fonts 114 are used as part of a ground truth for the training data 1404.

FIG. 18 depicts the ML model 142 receiving the input font properties 1406 that are of a predicted font from the operating environment 1100, and first font properties 1302. The first font properties 1302 are those of the first font 302 provided by the user. The trained ML model 142 predicts the output font properties 1408 based on such input. The output font properties 1408 are assigned to the predicted font. As described elsewhere herein (see block 908), the sample window 504 is updated to show the predicted font with the output font properties 1408.

FIG. 19 depicts an example composite font rendering 1902 in a text object with the font rendering parameters as predicted by the font-property-prediction model 1402. As depicted in the composite font rendering 1902, a sequence of glyphs for the composite font 114 are aligned across various font properties (e.g., a height, width, base line, center line, size, etc.) to ensure a uniform appearance across each line in a sequence of glyphs. The composite font rendering 1902 comprises a combination of glyphs from a Latin font and an Asian font, where glyphs from one font are interleaved with glyphs from the other font in the sequence of glyphs. The result is a uniform and visually appealing composite font 114 when presented on an electronic display device 404 of the control device 402.

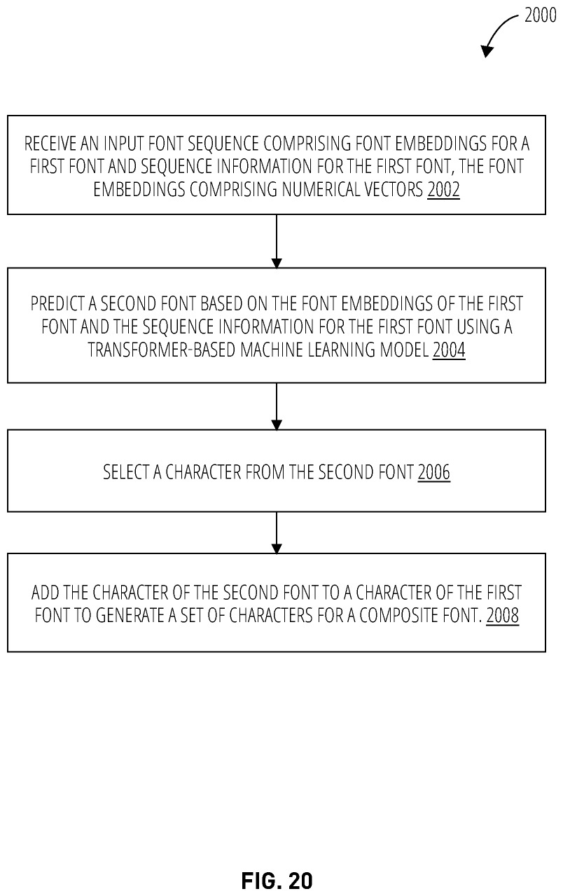

FIG. 20 illustrates an embodiment of a logic flow 2000. The logic flow 2000 is representative of some or all of the operations executed by one or more embodiments described herein. For example, the logic flow 2000 includes some or all of the operations performed by devices or entities within the apparatus 116. In one embodiment, the logic flow 2000 is implemented as instructions stored on a non-transitory computer-readable storage medium, such as the storage medium 2122, that when executed by the processing circuitry 2118 causes the processing circuitry 2118 to perform the described operations. The storage medium 2122 and processing circuitry 2118 may be co-located, or the instructions may be stored remotely from the processing circuitry 2118. Collectively, the storage medium 2122 and the processing circuitry 2118 may form a system.

In block 2002, logic flow 2000 receives an input font sequence comprising font embeddings for a first font and sequence information for the first font, the font embeddings comprising numerical vectors. In block 2004, logic flow 2000 predicts a second font based on the font embeddings of the first font and the sequence information for the first font using a transformer-based machine learning model. In block 2006, logic flow 2000 selects a character from the second font. In block 2008, logic flows 2000 adds the character of the second font to a character of the first font to generate a set of characters for a composite font.

By way of example, with reference to the apparatus 116, the composite font editor 104 uses two different ML models, such as ML model 126 and ML model 142, for different operations of generating the composite font 114.

A font recommendation module 106 of the composite font editor 104 uses a first ML model 126 to predict a recommended font 124, which is a next font in a sequence of fonts. During initialization, a user 128 selects a first font 302, and the first ML model 126 predicts a second font 332 that is visually compatible with the first font 302 to generate the composite font 114. The first ML model 126 then predicts the first font 302 or the second font 332 to apply to a character or range of characters in the composite font 114. This proceeds in an iterative manner until all characters are added to the composite font 114. The first ML model 126 is similar to a transformer for a LLM, which selects a next word in a sequence of words, and therefore it is better at predicting a next font in a sequence of fonts.

A font property recommendation module 108 of the composite font editor 104 uses a second ML model 126 to adjust a recommended font property 140 for the first font 302 or the second font 332 (e.g., a baseline, size, height, width, centerline, etc.) so that the character sequence is uniform or harmonized in an aesthetically pleasing manner (e.g., normalizing baselines). After the first ML model 126 predicts a recommended font 124 to apply to a character, the second ML model 142 predicts an adjustment to a recommended font property 140 for the character. The second ML model 142 is a deep CNN, and it is better at processing the pure numerical values used to represent the font properties. The first ML model 126 could work, but it has some problems such as overfitting to the training data 1206.

In one embodiment, for example, the ML model 126 of the font recommendation module 106 of the font editing application 102 receives an input font sequence 1022 includes font embeddings 204 for a first font 302 and sequence information for the first font 302. The font embeddings 204 comprise numerical vectors of N dimensions. The ML model 126 decodes information from the input font sequence 1022, and it predicts a second font 332 based on the font embeddings 204 of the first font 302 and the sequence information for the first font 302 using a transformer-based machine learning model. The composite font editor 104 then selects one or more characters from the second font. The composite font editor 104 adds the one or more characters of the second font to one or more characters of the first font to generate a set of characters for a composite font.

In one embodiment, the input font sequence 1022 includes sequence information for the font embeddings 204 of the first font 302, the sequence information to indicate a position for the font embeddings 204 of the first font 302 in a sequential order of tokens. For example, assume the input font sequence 1022 comprises a format of: <start token>, <font embedding 1>, pad token. In this example, the <start token> is in position 0, the <font embedding 1> is in position 1, and the <pad token> is in position 3.

In one embodiment, the encoder 1102 of the ML model 126 encodes sequence information for the font embeddings 204 of the second font 332 into the input font sequence 1022. The sequence information indicates a position for the font embeddings 204 of the second font 332 in a sequential order relative to a position for the font embeddings 204 of the first font 302 in the sequential order of tokens. For example, assume the input font sequence 1022 comprises a format of: <start token>, <font embedding 1>, <font embedding 2>, <pad token>. In this example, the <start token> is in position 0, the <font embedding 1> is in position 1, the <font embedding 2> is in position 2, and the <pad token> is in position 3.

In one embodiment, the encoder 1102 encodes location information for the font embeddings 204 of the first font 302 into the input font sequence 1022. Additional or alternatively, the encoder 1102 encodes user profile information for the font embeddings 204 of the first font 302 into the input font sequence 1022. The ML model 126 predicts a second font 332 based on the font embeddings of the first font 302 and the location information or the user profile information using the transformer-based machine learning model.

In one embodiment, the ML model 126 predicts a recommended font property 140 for the second font 332 based on the font embeddings 204 of the first font 302 using a multilayer perceptron (MLP) regression model, such as the ML model 142. The composite font editor 104 uses the recommended font property 140 to adjust a font property of the first font 302 or the second font 332 to harmonize characters from the first font 302 and the second font 332 in a line of characters.

In one embodiment, the decoder 1104 of the ML model 126 decodes the font embeddings 204 of the first font 302, the font embeddings 204 for the second font 332, and sequence information indicating a position for the font embeddings 204 of the first font 302 and a position for the font embeddings 204 of the second font 332 in a sequential order from the input font sequence 1022. The inferencing module 1116 of the ML model 126 predicts a third font based on the font embeddings 204 of the first font 302, the font embeddings 204 of the second font 332, and the sequential information for the font embeddings 204 of the first font 302 and the font embeddings 204 for the second font 332. The font recommendation module 106 then adds the third font to the composite font 114.

FIG. 21 illustrates an embodiment of a system 2100. The system 2100 is suitable for implementing one or more embodiments as described herein. In one embodiment, for example, the system 2100 is an AI/ML system suitable for performing personalized font recommendation for composite font creation.

The system 2100 comprises a set of M devices, where M is any positive integer. FIG. 21 depicts three devices (M=3), including a client device 2102, an inferencing device 2104, and a client device 2106. The inferencing device 2104 communicates information with the client device 2102 and the client device 2106 over a network 2108 and a network 2110, respectively. In one embodiment, for example, the inferencing device 2104 comprises a server device that implements the operating environment 1100 and/or the font-property-prediction model for the DTP system 400. The client device 2102 and the client device 2106 are devices that implement a GUI interface, such as a web browser, to remotely access multimodal search services offered by the inferencing device 2104. In one embodiment, for example, the inferencing device 2104 is a client device 2102 or the client device 2106, such as a smartphone, tablet, laptop computer or desktop computer, that executes a GUI to directly interact with the DTP system 400 executing locally on the inferencing device 2104.

The information includes input 2112 from the client device 2102 and output 2114 to the client device 2106, or vice-versa. An example of the input 2112 is a first component-font 516. An example of the output 2114 is second component-font 516. In one alternative, the input 2112 and the output 2114 are communicated between the same client device 2102 or client device 2106. In another alternative, the input 2112 and the output 2114 are stored in a data repository 2116. In yet another alternative, the input 2112 and the output 2114 are communicated via a platform component 2126 of the inferencing device 2104, such as an input/output (I/O) device (e.g., a touchscreen, a microphone, a speaker, etc.).

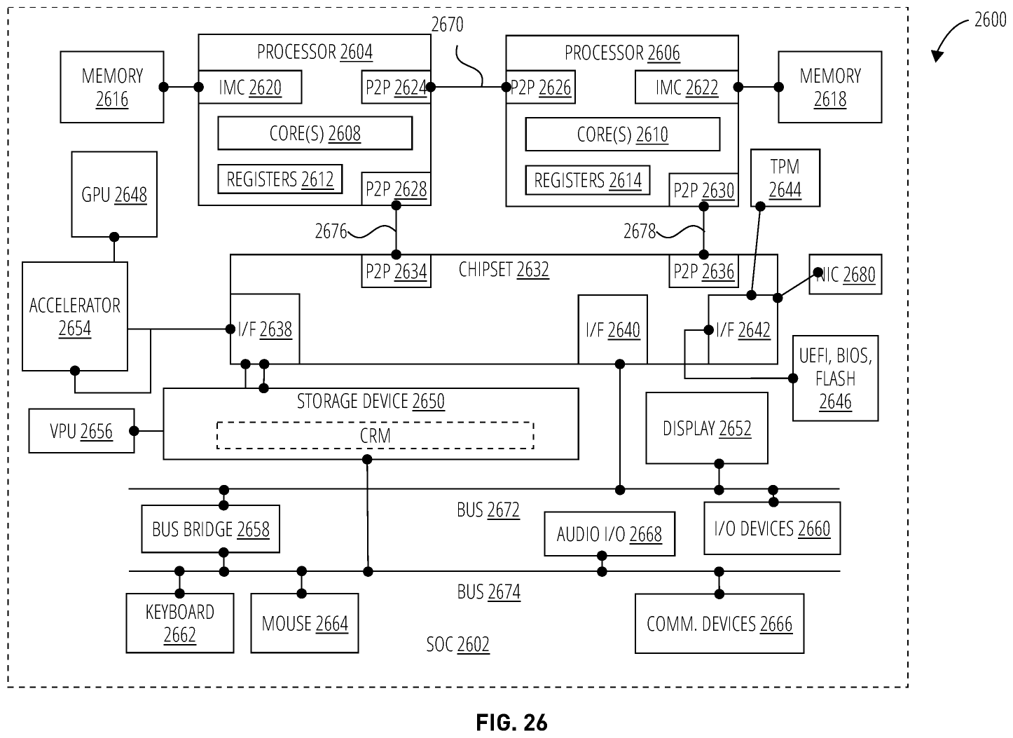

As depicted in FIG. 21, the inferencing device 2104 includes processing circuitry 2118, a memory 2120, a storage medium 2122, an interface 2124, a platform component 2126, ML logic 2128, and an ML model 2130. The ML logic 2128 executes operations to support the composite font creation of the DTP system 400. The ML model 2130 is one of the operating environment 1100 or the font-property-prediction model 1402. In some implementations, the inferencing device 2104 includes other components or devices as well. Examples for software elements and hardware elements of the inferencing device 2104 are described in more detail with reference to a computing architecture 2600 as depicted in FIG. 26. Embodiments are not limited to these examples.

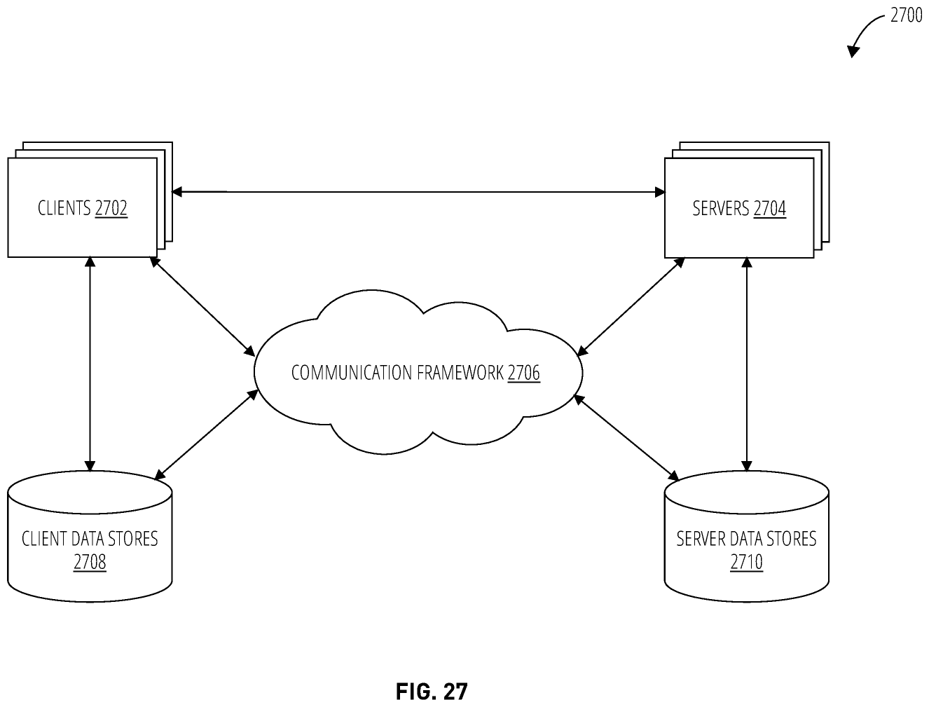

The inferencing device 2104 is generally arranged to receive an input 2112, process the input 2112 via one or more AI/ML techniques, and send an output 2114. The inferencing device 2104 receives the input 2112 from the client device 2102 via the network 2108, the client device 2106 via the network 2110, the platform component 2126 (e.g., a touchscreen as a text command or microphone as a voice command), the memory 2120, the storage medium 2122 or the data repository 2116. The inferencing device 2104 sends the output 2114 to the client device 2102 via the network 2108, the client device 2106 via the network 2110, the platform component 2126 (e.g., a touchscreen to present text, graphic or video information or speaker to reproduce audio information), the memory 2120, the storage medium 2122 or the data repository 2116. Examples for the software elements and hardware elements of the network 2108 and the network 2110 are described in more detail with reference to a communications architecture 2700 as depicted in FIG. 27. Embodiments are not limited to these examples.

The inferencing device 2104 includes ML logic 2128 and an ML model 2130 to implement various AI/ML techniques for various AI/ML tasks. The ML logic 2128 receives the input 2112, and processes the input 2112 using the ML model 2130. The ML model 2130 performs inferencing operations to generate an inference for a specific task from the input 2112. In some cases, the inference is part of the output 2114. The output 2114 is used by the client device 2102, the inferencing device 2104, or the client device 2106 to perform subsequent actions in response to the output 2114.

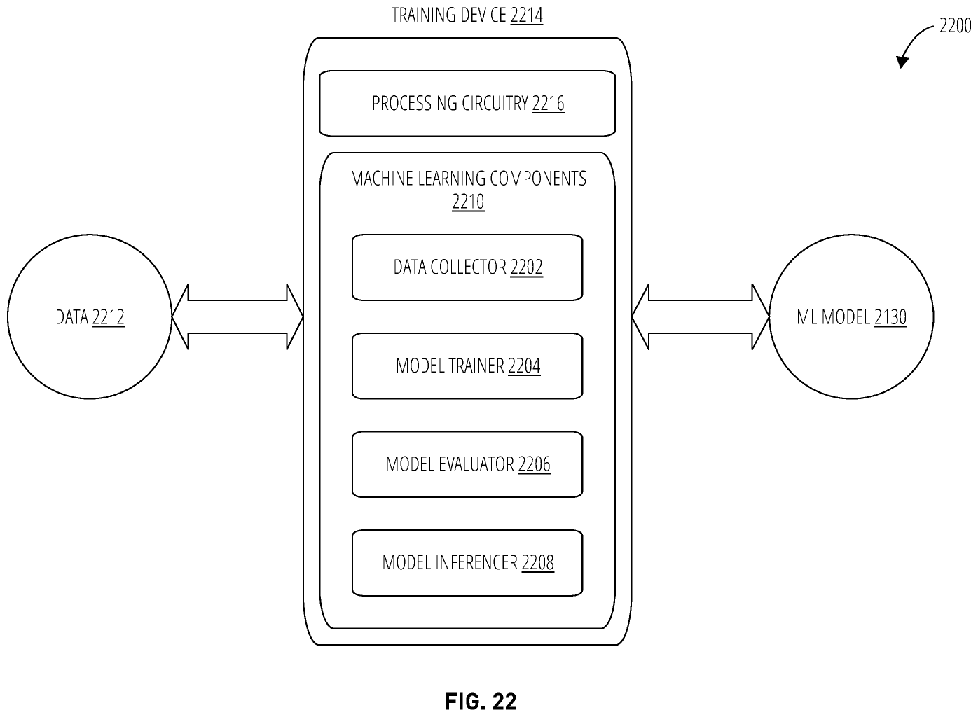

In various embodiments, the ML model 2130 is a trained ML model 2130 using a set of training operations. An example of training operations to train the ML model 2130 is described with reference to FIG. 22.

FIG. 22 illustrates an apparatus 2200. The apparatus 2200 depicts a training device 2214 suitable to generate a trained ML model 2130 for the inferencing device 2104 of the system 2100. In one embodiment, the training device 2214 executes various ML components 2210 to generate operating environment 1100 or the font-property-prediction model 1402 by training and testing an operating environment 1100 or a font-property-prediction model 1402.

As depicted in FIG. 22, the training device 2214 includes a processing circuitry 2216 and a set of ML components 2210 to support various AI/ML techniques, such as a data collector 2202, a model trainer 2204, a model evaluator 2206 and a model inferencer 2208.

In general, the data collector 2202 collects data 2212 from one or more data sources to use as training data for the ML model 2130. The data collector 2202 collects different types of data 2212, such as text information, audio information, image information, video information, graphic information, and so forth. The model trainer 2204 receives as input the collected data and uses a portion of the collected data as test data for an AI/ML algorithm to train the ML model 2130. The model evaluator 2206 evaluates and improves the trained ML model 2130 using a portion of the collected data as test data to test the ML model 2130. The model evaluator 2206 also uses feedback information from the deployed ML model 2130. The model inferencer 2208 implements the trained ML model 2130 to receive as input new unseen data, generate one or more inferences on the new data, and output a result such as an alert, a recommendation or other post-solution activity.

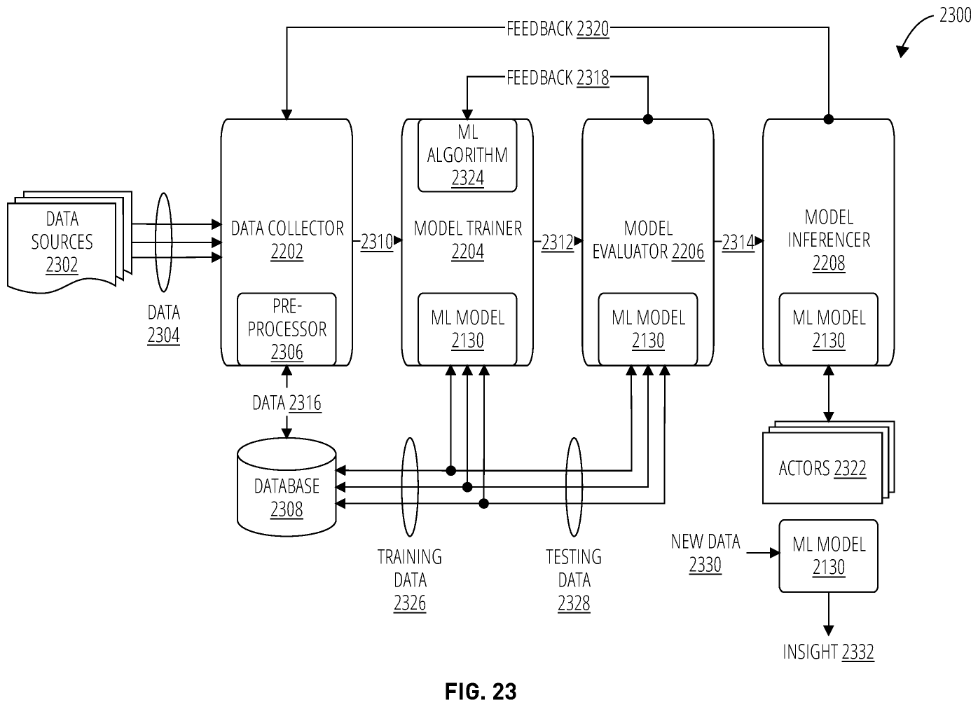

An exemplary AI/ML architecture for the ML components 2210 is described in more detail with reference to FIG. 23.

FIG. 23 illustrates an artificial intelligence architecture 2300 suitable for use by the training device 2214 to generate the ML model 2130 for deployment by the inferencing device 2104. The artificial intelligence architecture 2300 is an example of a system suitable for implementing various AI techniques and/or ML techniques to perform various inferencing tasks on behalf of the various devices of the system 2100.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 2300 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 2130, evaluate performance of the trained ML model 2130, and deploy the tested ML model 2130 as the trained ML model 2130 in a production environment, and continuously monitor and maintain it.

The ML model 2130 is a mathematical construct used to predict outcomes based on a set of input data. The ML model 2130 is trained using large volumes of training data 2326, and it can recognize patterns and trends in the training data 2326 to make accurate predictions. The ML model 2130 is derived from an ML algorithm 2324 (e.g., a neural network, decision tree, support vector machine, etc.). A data set is fed into the ML algorithm 2324 which trains an ML model 2130 to “learn” a function that produces mappings between a set of inputs and a set of outputs with a reasonably high accuracy. Given a sufficiently large enough set of inputs and outputs, the ML algorithm 2324 finds the function for a given task. This function may even be able to produce the correct output for input that it has not seen during training. A data scientist prepares the mappings, selects and tunes the ML algorithm 2324, and evaluates the resulting model performance. Once the ML logic 2128 is sufficiently accurate on test data, it can be deployed for production use.

The ML algorithm 2324 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 2324 of the artificial intelligence architecture 2300 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 23, the artificial intelligence architecture 2300 includes a set of data sources 2302 to source data 2304 for the artificial intelligence architecture 2300. Data sources 2302 may comprise any device capable generating, processing, storing or managing data 2304 suitable for a ML system. Examples of data sources 2302 include without limitation databases, web scraping, sensors and Internet of Things (IoT) devices, image and video cameras, audio devices, text generators, publicly available databases, private databases, and many other data sources 2302. The data sources 2302 may be remote from the artificial intelligence architecture 2300 and accessed via a network, local to the artificial intelligence architecture 2300 an accessed via a network interface, or may be a combination of local and remote data sources 2302.

The data sources 2302 source difference types of data 2304. By way of example and not limitation, the data 2304 includes structured data from relational databases, such as customer profiles, transaction histories, or product inventories. The data 2304 includes unstructured data from websites such as customer reviews, news articles, social media posts, or product specifications. The data 2304 includes data from temperature sensors, motion detectors, and smart home appliances. The data 2304 includes image data from medical images, security footage, or satellite images. The data 2304 includes audio data from speech recognition, music recognition, or call centers. The data 2304 includes text data from emails, chat logs, customer feedback, news articles or social media posts. The data 2304 includes publicly available datasets such as those from government agencies, academic institutions, or research organizations. These are just a few examples of the many sources of data that can be used for ML systems. It is important to note that the quality and quantity of the data is critical for the success of a machine learning project.

The data 2304 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 2302 are communicatively coupled to a data collector 2202. The data collector 2202 gathers relevant data 2304 from the data sources 2302. Once collected, the data collector 2202 may use a pre-processor 2306 to make the data 2304 suitable for analysis. This involves data cleaning, transformation, and feature engineering. Data preprocessing is a critical step in ML as it directly impacts the accuracy and effectiveness of the ML model 2130. The pre-processor 2306 receives the data 2304 as input, processes the data 2304, and outputs pre-processed data 2316 for storage in a database 2308. Examples for the database 2308 includes a hard drive, solid state storage, and/or random access memory (RAM).

The data collector 2202 is communicatively coupled to a model trainer 2204. The model trainer 2204 performs AI/ML model training, validation, and testing which may generate model performance metrics as part of the model testing procedure. The model trainer 2204 receives the pre-processed data 2316 as input 2310 or via the database 2308. The model trainer 2204 implements a suitable ML algorithm 2324 to train an ML model 2130 on a set of training data 2326 from the pre-processed data 2316. The training process involves feeding the pre-processed data 2316 into the ML algorithm 2324 to produce or optimize an ML model 2130. The training process adjusts its parameters until it achieves an initial level of satisfactory performance.

The model trainer 2204 is communicatively coupled to a model evaluator 2206. After an ML model 2130 is trained, the ML model 2130 needs to be evaluated to assess its performance. This is done using various metrics such as accuracy, precision, recall, and F1 score. The model trainer 2204 outputs the ML model 2130, which is received as input 2310 or from the database 2308. The model evaluator 2206 receives the ML model 2130 as input 2312, and it initiates an evaluation process to measure performance of the ML model 2130. The evaluation process includes providing feedback 2318 to the model trainer 2204. The model trainer 2204 re-trains the ML model 2130 to improve performance in an iterative manner.

The model evaluator 2206 is communicatively coupled to a model inferencer 2208. The model inferencer 2208 provides AI/ML model inference output (e.g., inferences, predictions or decisions). Once the ML model 2130 is trained and evaluated, it is deployed in a production environment where it is used to make predictions on new data. The model inferencer 2208 receives the evaluated ML model 2130 as input 2314. The model inferencer 2208 uses the evaluated ML model 2130 to produce insights or predictions on real data, which is deployed as a final production ML model 2130. The inference output of the ML model 2130 is use case specific. The model inferencer 2208 also performs model monitoring and maintenance, which involves continuously monitoring performance of the ML model 2130 in the production environment and making any necessary updates or modifications to maintain its accuracy and effectiveness. The model inferencer 2208 provides feedback 2318 to the data collector 2202 to train or re-train the ML model 2130. The feedback 2318 includes model performance feedback information, which is used for monitoring and improving performance of the ML model 2130.

Some or all of the model inferencer 2208 is implemented by various actors 2322 in the artificial intelligence architecture 2300, including the ML model 2130 of the inferencing device 2104, for example. The actors 2322 use the deployed ML model 2130 on new data to make inferences or predictions for a given task, and output an insight 2332. The actors 2322 implement the model inferencer 2208 locally, or remotely receives outputs from the model inferencer 2208 in a distributed computing manner. The actors 2322 trigger actions directed to other entities or to itself. The actors 2322 provide feedback 2320 to the data collector 2202 via the model inferencer 2208. The feedback 2320 comprise data needed to derive training data, inference data or to monitor the performance of the ML model 2130 and its impact to the network through updating of key performance indicators (KPIs) and performance counters.

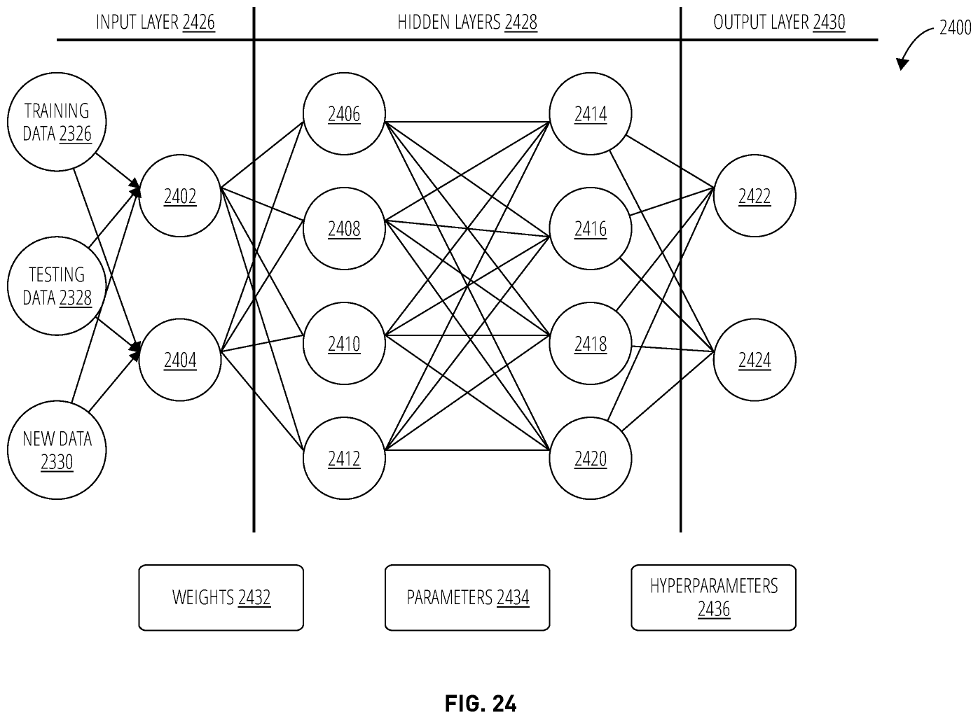

As previously described with reference to FIGS. 1, 2, the systems 2100, 2200 implement some or all of the artificial intelligence architecture 2300 to support various use cases and solutions for various AI/ML tasks. In various embodiments, the training device 2214 of the apparatus 2200 uses the artificial intelligence architecture 2300 to generate and train the ML model 2130 for use by the inferencing device 2104 for the system 2100. In one embodiment, for example, the training device 2214 may train the ML model 2130 as a neural network, as described in more detail with reference to FIG. 24. Other use cases and solutions for AI/ML are possible as well, and embodiments are not limited in this context.

FIG. 24 illustrates an embodiment of an artificial neural network 2400. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 2400 comprises multiple node layers, containing an input layer 2426, one or more hidden layers 2428, and an output layer 2430. Each layer comprises one or more nodes, such as nodes 2402 to 2424. As depicted in FIG. 24, for example, the input layer 2426 has nodes 2402, 2404. The artificial neural network 2400 has two hidden layers 2428, with a first hidden layer having nodes 2406, 2408, 2410 and 2412, and a second hidden layer having nodes 2414, 2416, 2418 and 2420. The artificial neural network 2400 has an output layer 2430 with nodes 2422, 2424. Each node 2402 to 2424 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 2400 relies on training data 2326 to learn and improve accuracy over time. However, once the artificial neural network 2400 is fine-tuned for accuracy, and tested on testing data 2328, the artificial neural network 2400 is ready to classify and cluster new data 2330 at a high velocity. Tasks in speech recognition or image recognition can take minutes versus hours when compared to the manual identification by human experts.

Each individual node 2402 to 424 is a linear regression model, composed of input data, weights, a bias (or threshold), and an output. Once an input layer 2426 is determined, a set of weights 2432 are assigned. The weights 2432 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 2400 as a feedforward network.

In one embodiment, the artificial neural network 2400 leverages sigmoid neurons, which are distinguished by having values between 0 and 1. Since the artificial neural network 2400 behaves similarly to a decision tree, cascading data from one node to another, having x values between 0 and 1 will reduce the impact of any given change of a single variable on the output of any given node, and subsequently, the output of the artificial neural network 2400.

The artificial neural network 2400 has many practical use cases, like image recognition, speech recognition, text recognition or classification. The artificial neural network 2400 leverages supervised learning, or labeled datasets, to train the algorithm. As the model is trained, its accuracy is measured using a cost (or loss) function. This is also commonly referred to as the mean squared error (MSE).

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 2434 of the model adjust to gradually converge at the minimum.

In one embodiment, the artificial neural network 2400 is feedforward, meaning it flows in one direction only, from input to output. In one embodiment, the artificial neural network 2400 uses backpropagation. Backpropagation is when the artificial neural network 2400 moves in the opposite direction from output to input. Backpropagation allows calculation and attribution of errors associated with each neuron 2402 to 2424, thereby allowing adjustment to fit the parameters 2434 of the ML model 2130 appropriately.

The artificial neural network 2400 is implemented as different neural networks depending on a given task. Neural networks are classified into different types, which are used for different purposes. In one embodiment, the artificial neural network 2400 is implemented as a feedforward neural network, or multi-layer perceptrons (MLPs), comprised of an input layer 2426, hidden layers 2428, and an output layer 2430. While these neural networks are also commonly referred to as MLPs, they are actually comprised of sigmoid neurons, not perceptrons, as most real-world problems are nonlinear. Trained data 2304 usually is fed into these models to train them, and they are the foundation for computer vision, natural language processing, and other neural networks. In one embodiment, the artificial neural network 2400 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 2400 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 2400 is implemented as any type of neural network suitable for a given operational task of system 2100, and the MLP, CNN, and RNN are merely a few examples. Embodiments are not limited in this context.

The artificial neural network 2400 includes a set of associated parameters 2434. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 2400 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 2436. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

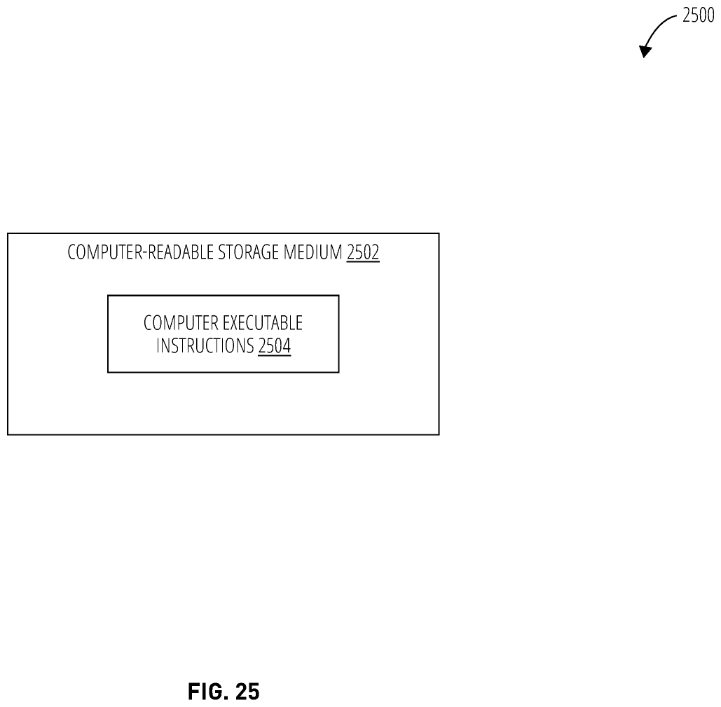

FIG. 25 illustrates an apparatus 2500. Apparatus 2500 comprises any non-transitory computer-readable storage medium 2502 or machine-readable storage medium, such as an optical, magnetic or semiconductor storage medium. In various embodiments, apparatus 2500 comprises an article of manufacture or a product. In some embodiments, the computer-readable storage medium 2502 stores computer executable instructions with which one or more processing devices or processing circuitry can execute. For example, computer executable instructions 2504 includes instructions to implement operations described with respect to any logic flows described herein. Examples of computer-readable storage medium 2502 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 2504 include any suitable type of code, such as source code, compiled code, interpreted code, executable code, static code, dynamic code, object-oriented code, visual code, and the like.

FIG. 26 illustrates an embodiment of a computing architecture 2600. Computing architecture 2600 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 2600 has a single processor with one core or more than one processor. Note that the term “processor” refers to a processor with a single core or a processor package with multiple processor cores. In at least one embodiment, the computing architecture 2600 is representative of the components of the system 2100. More generally, the computing architecture 2600 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 2600. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 26, computing architecture 2600 comprises a system-on-chip (SoC) 2602 for mounting platform components. System-on-chip (SoC) 2602 is a point-to-point (P2P) interconnect platform that includes a first processor 2604 and a second processor 2606 coupled via a point-to-point interconnect 2670 such as an Ultra Path Interconnect (UPI). In other embodiments, the computing architecture 2600 is another bus architecture, such as a multi-drop bus. Furthermore, each of processor 2604 and processor 2606 are processor packages with multiple processor cores including core(s) 2608 and core(s) 2610, respectively. While the computing architecture 2600 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 2604 and chipset 2632. Some platforms include additional components and some platforms include sockets to mount the processors and/or the chipset. Furthermore, some platforms do not have sockets (e.g., SoC, or the like). Although depicted as a SoC 2602, one or more of the components of the SoC 2602 are included in a single die package, a multi-chip module (MCM), a multi-die package, a chiplet, a bridge, and/or an interposer. Therefore, embodiments are not limited to a SoC.

The processor 2604 and processor 2606 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 2604 and/or processor 2606. Additionally, the processor 2604 need not be identical to processor 2606.

Processor 2604 includes an integrated memory controller (IMC) 2620 and point-to-point (P2P) interface 2624 and P2P interface 2628. Similarly, the processor 2606 includes an IMC 2622 as well as P2P interface 2626 and P2P interface 2630. IMC 2620 and IMC 2622 couple the processor 2604 and processor 2606, respectively, to respective memories (e.g., memory 2616 and memory 2618). Memory 2616 and memory 2618 are portions of the main memory (e.g., a dynamic random-access memory (DRAM)) for the platform such as double data rate type 4 (DDR4) or type 5 (DDR5) synchronous DRAM (SDRAM). In the present embodiment, the memory 2616 and the memory 2618 locally attach to the respective processors (i.e., processor 2604 and processor 2606). In other embodiments, the main memory couple with the processors via a bus and shared memory hub. Processor 2604 includes registers 2612 and processor 2606 includes registers 2614.

Computing architecture 2600 includes chipset 2632 coupled to processor 2604 and processor 2606. Furthermore, chipset 2632 are coupled to storage device 2650, for example, via an interface (I/F) 2638. The I/F 2638 may be, for example, a Peripheral Component Interconnect-enhanced (PCIe) interface, a Compute Express Link® (CXL) interface, or a Universal Chiplet Interconnect Express (UCIe) interface. Storage device 2650 stores instructions executable by circuitry of computing architecture 2600 (e.g., processor 2604, processor 2606, GPU 2648, accelerator 2654, vision processing unit 2656, or the like). For example, storage device 2650 can store instructions for the client device 2102, the client device 2106, the inferencing device 2104, the training device 2214, or the like.

Processor 2604 couples to the chipset 2632 via P2P interface 2628 and P2P 2634 while processor 2606 couples to the chipset 2632 via P2P interface 2630 and P2P 2636. Direct media interface (DMI) 2676 and DMI 2678 couple the P2P interface 2628 and the P2P 2634 and the P2P interface 2630 and P2P 2636, respectively. DMI 2676 and DMI 2678 is a high-speed interconnect that facilitates, e.g., eight Giga Transfers per second (GT/s) such as DMI 3.0. In other embodiments, the processor 2604 and processor 2606 interconnect via a bus.

The chipset 2632 comprises a controller hub such as a platform controller hub (PCH). The chipset 2632 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 2632 comprises more than one controller hub such as a chipset with a memory controller hub, a graphics controller hub, and an input/output (I/O) controller hub.

In the depicted example, chipset 2632 couples with a trusted platform module (TPM) 2644 and UEFI, BIOS, FLASH circuitry 2646 via I/F 2642. The TPM 2644 is a dedicated microcontroller designed to secure hardware by integrating cryptographic keys into devices. The UEFI, BIOS, FLASH circuitry 2646 may provide pre-boot code. The I/F 2642 may also be coupled to a network interface circuit (NIC) 2680 for connections off-chip.

Furthermore, chipset 2632 includes the I/F 2638 to couple chipset 2632 with a high-performance graphics engine, such as, graphics processing circuitry or a graphics processing unit (GPU) 2648. In other embodiments, the computing architecture 2600 includes a flexible display interface (FDI) (not shown) between the processor 2604 and/or the processor 2606 and the chipset 2632. The FDI interconnects a graphics processor core in one or more of processor 2604 and/or processor 2606 with the chipset 2632.

The computing architecture 2600 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 2654 and/or vision processing unit 2656 are coupled to chipset 2632 via I/F 2638. The accelerator 2654 is representative of any type of accelerator device (e.g., a data streaming accelerator, cryptographic accelerator, cryptographic co-processor, an offload engine, etc.). One example of an accelerator 2654 is the Intel® Data Streaming Accelerator (DSA). The accelerator 2654 is a device including circuitry to accelerate copy operations, data encryption, hash value computation, data comparison operations (including comparison of data in memory 2616 and/or memory 2618), and/or data compression. Examples for the accelerator 2654 include a USB device, PCI device, PCIe device, CXL device, UCIe device, and/or an SPI device. The accelerator 2654 also includes circuitry arranged to execute machine learning (ML) related operations (e.g., training, inference, etc.) for ML models. Generally, the accelerator 2654 is specially designed to perform computationally intensive operations, such as hash value computations, comparison operations, cryptographic operations, and/or compression operations, in a manner that is more efficient than when performed by the processor 2604 or processor 2606. Because the load of the computing architecture 2600 includes hash value computations, comparison operations, cryptographic operations, and/or compression operations, the accelerator 2654 greatly increases performance of the computing architecture 2600 for these operations.

The accelerator 2654 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 2654. For example, the accelerator 2654 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 2654 via a non-posted write (e.g., a deferred memory write (DMWr)). One example of an instruction that atomically submits a work descriptor to the shared work queue of the accelerator 2654 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 2654. The dedicated work queue may accept job submissions via commands such as the movdir64b instruction.

Various I/O devices 2660 and display 2652 couple to the bus 2672, along with a bus bridge 2658 which couples the bus 2672 to a second bus 2674 and an I/F 2640 that connects the bus 2672 with the chipset 2632. In one embodiment, the second bus 2674 is a low pin count (LPC) bus. Various input/output (I/O) devices couple to the second bus 2674 including, for example, a keyboard 2662, a mouse 2664 and communication devices 2666.

Furthermore, an audio I/O 2668 couples to second bus 2674. Many of the I/O devices 2660 and communication devices 2666 reside on the system-on-chip (SoC) 2602 while the keyboard 2662 and the mouse 2664 are add-on peripherals. In other embodiments, some or all the I/O devices 2660 and communication devices 2666 are add-on peripherals and do not reside on the system-on-chip (SoC) 2602.

FIG. 27 illustrates a block diagram of an exemplary communications architecture 2700 suitable for implementing various embodiments as previously described. The communications architecture 2700 includes various common communications elements, such as a transmitter, receiver, transceiver, radio, network interface, baseband processor, antenna, amplifiers, filters, power supplies, and so forth. The embodiments, however, are not limited to implementation by the communications architecture 2700.

As shown in FIG. 27, the communications architecture 2700 includes one or more clients 2702 and servers 2704. The clients 2702 and the servers 2704 are operatively connected to one or more respective client data stores 2708 and server data stores 2710 that can be employed to store information local to the respective clients 2702 and servers 2704, such as cookies and/or associated contextual information.

The clients 2702 and the servers 2704 communicate information between each other using a communication framework 2706. The communication framework 2706 implements any well-known communications techniques and protocols. The communication framework 2706 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 2706 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/2100/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 2702 and the servers 2704. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

By leveraging the font-to-embeddings model 1106 and the transformer architecture, the proposed operating environment 1100 effectively captures the relationships between different fonts in the composite font and generates accurate recommendations for a next font to be added to the composite font based on the user's interaction history. Further, embodiments herein facilitate composite font creation workflows with the ability to personalize the composite fonts based on the user's locale and history. Personalization enables the DTP system 400 to cater composite font creation to the diverse needs and preferences of users, empowering them to make choices that align with their specific requirements. Additionally, considering the distinction between power users and novice users, the DTP system 400 may provide different levels of suggestions, ranging from global recommendations to locale-specific or personalized recommendations based on the user's history. Accordingly, embodiments herein provide technical solutions and practical applications in a digital-centric technical challenge of composite font creation by providing a personalized machine learning based models that encompass locale and user history considerations.

The operating environment 1100 and font-property-prediction model are trained and used separately by embodiments described herein. As described herein, the operating environment 1100 becomes subjective/contextual/regional and is a transformer based model trained using causal language modelling. The font-property-prediction model uses fonts metadata and regression modelling.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following examples pertain to further embodiments, from which numerous permutations and configurations will be apparent.

What is claimed is:

1. A method, comprising:
receiving an input font sequence comprising font embeddings for a first font and sequence information for the first font, the font embeddings comprising numerical vectors;
predicting a second font based on the font embeddings of the first font and the sequence information for the first font using a transformer-based machine learning model;
selecting a character from the second font; and
adding the character of the second font to a character of the first font to generate a set of characters for a composite font.

2. The method of claim 1, wherein the input font sequence comprises a sequence of tokens including a start token, a font embedding token for the first font, a pad token, and an end token.

3. The method of claim 1, wherein the sequence information for the font embeddings of the first font indicates a position for the font embeddings of the first font in a sequential order.

4. The method of claim 1, further comprising:
obtaining font embeddings of the second font;
adding the font embeddings of the second font to the input font sequence; and
encoding sequence information for the font embeddings of the second font into the input font sequence, the sequence information to indicate a position for the font embeddings of the second font in a sequential order relative to a position for the font embeddings of the first font in the sequential order.

5. The method of claim 4, comprising:
decoding the font embeddings of the first font, the font embeddings for the second font, and sequence information indicating a position for the font embeddings of the first font and a position for the font embeddings of the second font in a sequential order from the input font sequence;
predicting a third font based on the font embeddings of the first font, the font embeddings of the second font, and the sequential information for the font embeddings of the first font and the font embeddings for the second font; and
adding the third font to the composite font.

6. The method of claim 1, comprising:
encoding location information for the font embeddings of the first font into the input font sequence; and
predicting a second font based on the font embeddings of the first font and the location information using the transformer-based machine learning model.

7. The method of claim 1, comprising:
encoding user profile information for the font embeddings of the first font into the input font sequence; and
predicting a second font based on the font embeddings of the first font and the user profile information using the transformer-based machine learning model.

8. The method of claim 1, comprising predicting a font property for the second font based on the font embeddings of the first font using a multilayer perceptron (MLP) regression model, the font property comprising a baseline, a center glyph, a horizontal scale, a vertical scale or a size for the second font.

9. A non-transitory computer-readable medium storing executable instructions, which when executed by one or more processing devices, cause the one or more processing devices to perform operations comprising:
receiving an input font sequence comprising font embeddings for a first font and sequence information for the first font, the font embeddings comprising numerical vectors;
predicting a second font based on the font embeddings of the first font and the sequence information for the first font using a transformer-based machine learning model;
selecting a character from the second font; and
adding the character of the second font to a character of the first font to generate a set of characters for a composite font.

10. The computer-readable storage medium of claim 9, wherein the sequence information for the font embeddings of the first font indicates a position for the font embeddings of the first font in a sequential order.

11. The computer-readable storage medium of claim 9, comprising instructions for:
obtaining font embeddings of the second font;
adding the font embeddings of the second font to the input font sequence; and
encoding sequence information for the font embeddings of the second font into the input font sequence, the sequence information to indicate a position for the font embeddings of the second font in a sequential order relative to a position for the font embeddings of the first font in the sequential order.

12. The computer-readable storage medium of claim 11, comprising instructions for:
decoding the font embeddings of the first font, the font embeddings for the second font, and sequence information indicating a position for the font embeddings of the first font and a position for the font embeddings of the second font in a sequential order from the input font sequence;
predicting a third font based on the font embeddings of the first font, the font embeddings of the second font, and the sequential information for the font embeddings of the first font and the font embeddings for the second font; and
adding the third font to the composite font.

13. The computer-readable storage medium of claim 9, comprising instructions for:
encoding location information for the font embeddings of the first font into the input font sequence; or
encoding user profile information for the font embeddings of the first font into the input font sequence; and
predicting a second font based on the font embeddings of the first font and the location information or the user profile information using the transformer-based machine learning model.

14. The computer-readable storage medium of claim 9, comprising instructions for predicting a font property for the second font based on the font embeddings of the first font using a multilayer perceptron (MLP) regression model, the font property comprising a baseline, a center glyph, a horizontal scale, a vertical scale or a size for the second font.

15. An apparatus, comprising:
a memory component; and
one or more processing devices coupled to the memory component, the one or more processing devices to perform operations comprising:
receiving an input font sequence comprising font embeddings for a first font and sequence information for the first font, the font embeddings comprising numerical vectors;
predicting a second font based on the font embeddings of the first font and the sequence information for the first font using a transformer-based machine learning model; and
selecting a character from the second font; and
adding the character of the second font to a character of the first font to generate a set of characters for a composite font.

16. The method of claim 15, wherein the sequence information for the font embeddings of the first font indicates a position for the font embeddings of the first font in a sequential order.

17. The method of claim 15, further comprising:
obtaining font embeddings of the second font;
adding the font embeddings of the second font to the input font sequence; and
encoding sequence information for the font embeddings of the second font into the input font sequence, the sequence information to indicate a position for the font embeddings of the second font in a sequential order relative to a position for the font embeddings of the first font in the sequential order.

18. The method of claim 17, comprising:
decoding the font embeddings of the first font, the font embeddings for the second font, and sequence information indicating a position for the font embeddings of the first font and a position for the font embeddings of the second font in a sequential order from the input font sequence;
predicting a third font based on the font embeddings of the first font, the font embeddings of the second font, and the sequential information for the font embeddings of the first font and the font embeddings for the second font; and
adding the third font to the composite font.

19. The method of claim 15, comprising:
encoding location information for the font embeddings of the first font into the input font sequence; or
encoding user profile information for the font embeddings of the first font into the input font sequence; and
predicting a second font based on the font embeddings of the first font and the location information or the user profile information using the transformer-based machine learning model.

20. The method of claim 15, further comprising predicting a font property for the second font based on the font embeddings of the first font using a multilayer perceptron (MLP) regression model, the font property comprising a baseline, a center glyph, a horizontal scale, a vertical scale or a size for the second font.
